(19) United States
(12) Patent Application Publication
(10) Pub. No.: US 2015/0166293 A1
(43) Pub. Date: Jun. 18, 2015

(54) BOUNDARY DETERMINATION METHOD AND MEDIA CUTTING METHOD

(71) Applicant: MIMAKI ENGINEERING CO., LTD., NAGANO (JP)

(72) Inventors: SATOSHI HAMAMURA, NAGANO (JP); HIROYOSHI OHI, NAGANO (JP)

(21) Appl. No.: 14/569,802

(22) Filed: Dec. 15, 2014

(30) Foreign Application Priority Data
Dec. 18, 2013 (JP) 2013-260822

(51) Int. Cl. B65H 35/00; G06K 15/00

(52) U.S. Cl. CPC B65H 35/008; G06K 15/403; G06K 15/4065

(57) ABSTRACT

There are provided a boundary determination method and a media cutting method. The boundary determination method is a method of determining the position of the boundary between first and second image regions arranged on a medium. The boundary determination method includes: a detection step of checking position information of the first image region by detecting a reference mark that is formed in the first image region in order to indicate a position of the first image region; a prediction step of predicting position information of the second image region based on the position information of the first image region; and a determination step of determining the position of the boundary based on positional relationship between the first and second image regions calculated using the position information of the first and second image regions.

### CROSS REFERENCE TO RELATED APPLICATIONS

This application claims the priority benefit of Japan application serial no. 2013-260822, filed on Dec. 18, 2013. The entirety of the above-mentioned patent application is hereby incorporated by reference herein and made a part of this specification.

### TECHNICAL FIELD

The present invention relates to a boundary determination method and a media cutting method, and in particular, a boundary determination method for determining the position of the boundary of each image region disposed on a medium and a media cutting method for cutting a medium at a predetermined position calculated based on the position of the boundary.

### DESCRIPTION OF THE BACKGROUND ART

As an example of a cutting apparatus including a cutting head for cutting a medium, a cutting apparatus is known that cuts a medium by performing an operation of making the cutting head reciprocate to the left and right with respect to the medium supported by a platen and an operation of moving the medium back and forth in combination. On the other hand, a printer apparatus configured to print an image on the surface of a medium using a printer head for ejecting ink through discharge nozzles instead of the cutting head described above is also known.

In addition, a cutting apparatus configured to include a cutting head and a printer head has also been developed. By using the cutting apparatus, it is possible to perform printing and cutting continuously. For example, JP 2011-051192 A discloses a cutting apparatus configured to include a cutting head and a printer head.

More specifically, in the cutting apparatus, first, an image and, for example, four reference marks (hereinafter, may be called “register marks”) surrounding the image are printed using the printer head. Then, by detecting the positions of the register marks (reference marks) at the time of cutting using the cutting head, it is possible to check the printing position of the image with respect to the register marks (reference marks). Therefore, it is possible to perform cutting at a position corresponding to the image.

However, in the cutting method illustrated in JP 2011-051192 A, for example, as shown in FIG. 16, it is necessary to provide a margin S between adjacent image regions (for example, A1 to A6) of image regions to be cut on a medium (for example, the position of the boundary of the image region in FIG. 16 is shown by the two-dot chain line).

For this reason, a process of calculating a reference position P required for processing (cutting) by optically detecting a register mark (reference mark) T is performed. In this case, for example, as shown in FIG. 17, the reference position P is calculated by forming the reference mark T in an L shape and detecting the shapes (widths) of t1 and t2. Therefore, as shown in FIG. 18, when image regions are formed without providing a margin between adjacent image regions, it is not possible to distinguish adjacent reference marks in the adjacent image regions from each other as illustrated in the boundary between a reference mark T3 in an image region A and a reference mark T1 in an image region B, the boundary between a reference mark T4 in the image region A and a reference mark T2 in the image region B, or the boundary between a reference mark T2 in the image region A and a reference mark T1 in an image region C. As a result, it is not possible to calculate the reference position P.

In addition, shaded portions in diagrams are regions where printing is prohibited in order to allow the detection of a reference mark.

In the case of a configuration in which a margin should be provided between adjacent image regions of image regions to be cut as in the method described above, a region (margin portion) where no image can be printed is generated. Accordingly, a large medium that can cover at least the loss of the margin portion is required, and a problem that the margin portion is wasted can occur.

In addition, in the method described above, it is necessary to form the reference marks T1 to T4 at four locations in each image region. In this case, first of all, it takes time to form (print) the reference marks T1 to T4. In addition, since it is necessary to detect each of the reference marks formed at the four locations, so that it also takes time in detection and a problem that the time until each image region is cut is increased occurs.

### SUMMARY

The present invention has been made in view of the above problems, and an object of the present invention is to provide a boundary determination method and a media cutting method capable of reducing the time required to form and detect reference marks, which are required when determining the position of the boundary of an image region, and accordingly reducing the processing time while eliminating the waste of a medium when cutting the medium based on the position of the boundary.

As an embodiment, the above-described problems are solved by solving means disclosed below.

According to an aspect of the present invention, there is provided a boundary determination method for determining a position of a boundary between first and second image regions arranged on a medium. The boundary determination method includes: a detection step of checking position information of the first image region by detecting a reference mark that is formed in the first image region in order to indicate a position of the first image region; a prediction step of predicting position information of the second image region based on the position information of the first image region; and a determination step of determining the position of the boundary based on positional relationship between the first and second image regions calculated using the position information of the first and second image regions. In this case, since the prediction step is included, a larger amount of position information than the amount of information of positions actually formed can be used when performing the determination step. Therefore, it is possible to increase the accuracy of boundary determination (calculation).

In addition, in the present invention, preferably, the first and second image regions are image regions having the same shape and size arranged adjacent to each other on the medium, and the prediction step is a step of predicting the position information of the second image region using the position information and shape information of the first image region and shape information of the second image region. In this case, since the position information of the second image region is predicted using not only the position information of the first image region but also the shape information of the first and second image regions, it is possible to further increase the accuracy of the position information of the second image region. Therefore, an effect that the accuracy of boundary determination (calculation) is further improved is obtained.

In addition, in the present invention, preferably, the first and second image regions are two adjacent image regions of a plurality of rectangular image regions arranged in a matrix on the medium, and the prediction step is a step of predicting the position information of the second image region by calculation to translate the position information of the first image region. In this case, it is possible to predict (calculate) the position information of the second image region using a simple calculation method.

In addition, according to another aspect of the present invention, there is provided a boundary determination method for determining a position of a boundary of each image region on a sheet-like medium on which rectangular image regions having the same shape and size are arranged in a matrix in X and Y directions. The boundary determination method includes: a step (S1) of checking a position of a first reference point by detecting a first reference mark, which is formed at a corner closest to an origin of the medium, in an image region of first row and first column of the medium; a step (S2) of checking a position of a second reference point by detecting a second reference mark, which is formed at a corner different from the corner where the first reference mark is formed, in the image region of first row and first column; a step (S3) of checking a position of a reference point for margin detection by detecting a reference mark for margin detection, which is formed at a corner closest to the origin of the medium, in an image region of second row and second column of the medium; and a step (S4) of determining a position of a boundary in the image region of first row and first column using the first reference point, the second reference point, and an X-direction width and a Y-direction width of a margin adjacent to the image region of first row and first column calculated using the reference point for margin detection.

In this case, by forming only two reference marks in each image region on the sheet-like medium on which rectangular image regions having the same shape and size are arranged in a matrix in X and Y directions, it is possible to determine the position of the boundary of the image region of first row and first column on the medium. Therefore, it is possible to cut the image region at a predetermined cutting position set based on the position of the boundary. As a result, it is possible to reduce both the time required to form (print) a reference mark and the time required to detect a reference mark. Thus, since it is possible to significantly reduce the time required until the cutting of each image region from the formation of reference marks, the tact time of processing can be greatly reduced. As a result, it is possible to improve the processing efficiency.

In addition, it is possible to realize a configuration in which reference marks in adjacent image regions are not arranged adjacent to each other. Therefore, since it is possible to detect each reference mark even if there is no margin between adjacent image regions, it is possible to eliminate the margin. In this manner, the problem that the margin portion is wasted can be solved. In addition, since the medium itself can be reduced in size, it is possible to reduce the cost.

In addition, in the present invention, preferably, the steps (S1) to (S3) are included, and following steps are included instead of the step (S4). The following steps are: a step (S6) of checking a position of a third reference point by detecting a third reference mark, which is formed at a corner closest to the origin of the medium, in an image region of second row and first column of the medium; a step (S7) of checking a position of a fourth reference point by detecting a fourth reference mark, which is formed at a corner closest to the origin of the medium, in an image region of first row and second column of the medium; a step (S8) of predicting a position of a first prediction reference point at a corner in the image region of first row and first column, which is adjacent to the corner in the image region of second row and first column where the third reference mark is formed, using the third reference point in the image region of second row and first column; a step (S9) of predicting a position of a second prediction reference point at a corner in the image region of first row and first column, which is adjacent to the corner in the image region of first row and second column where the fourth reference mark is formed, using the fourth reference point in the image region of first row and second column; and a step (S10) of determining a position of a boundary in the image region of first row and first column using the first and second reference points, the first and second prediction reference points, and an X-direction width and a Y-direction width of a margin adjacent to the image region of first row and first column calculated using the reference point for margin detection. In this case, it is possible to obtain the position information of four points (first and second reference points and first and second prediction reference points) and the information of a margin by forming only two reference marks in each image region on the medium. Therefore, it is possible to further increase the calculation accuracy by calculating the boundary position using the information. In particular, even when not only a margin but also skew is present, it is possible to calculate the boundary position with high accuracy.

In addition, according to still another aspect of the present invention, there is provided a boundary determination method for determining a position of a boundary of each image region on a sheet-like medium on which rectangular image regions having the same shape and size are arranged in a matrix of M rows and N columns (M and N are natural numbers) in X and Y directions. The boundary determination method includes: the steps (S1) to (S4) or the steps (S1) to (S3) and (S6) to (S10) in the boundary determination method described above; a step (S21) of checking a position of a first reference point by detecting a first reference mark, which is formed at a corner closest to the origin of the medium, in each image region of m-th row and n-th column (1≦m≦M, 1≦n≦N) of the medium, the step (S21) overlapping the step (S1) or not overlapping the step (S1); a step (S22) of checking a position of a second reference point by detecting a second reference mark, which is formed at a corner different from the corner where the first reference mark is formed, in each image region of m-th row and n-th column, the step (S22) overlapping the step (S2) or not overlapping the step (S2); a step (S23) of predicting a position of a first prediction reference point at a corner in each image region of m-th row and k-th column (k=n+1, where 2≦k≦N−1) of the medium, which is adjacent to a corner in an image region of m-th row and (k−1)-th column where the second reference mark is formed, using the second reference point in the image region of m-th row and (k−1)-th column; a step (S24) of predicting a position of a second prediction reference point at a corner in each image region of m-th row and k-th column of the medium, which is adjacent to a corner in an image region of m-th row and (k+1)-th column where the first reference mark is formed, using the first reference point in the image region of m-th row and (k+1)-th column; and a step (S25) of determining a position of a boundary in each image region of m-th row and k-th column using the first and second reference points, the first and second prediction reference points, and the widths of the margin in each image region of m-th row and k-th column.

In this case, by forming only two reference marks in each image region on the sheet-like medium on which rectangular image regions having the same shape and size are arranged in a matrix in X and Y directions, it is possible to determine the position of the boundary of each image region of m-th row and k-th column on the medium. Therefore, it is possible to cut each image region at a predetermined cutting position set based on the position of the boundary. As a result, in the same manner as described above, it is possible to reduce both the time required to form (print) a reference mark and the time required to detect a reference mark. Thus, since it is possible to significantly reduce the time required until the cutting of each image region from the formation of reference marks, the tact time of processing can be greatly reduced. As a result, it is possible to improve the processing efficiency. In addition, it is possible to realize a configuration in which reference marks in adjacent image regions are not arranged adjacent to each other. Therefore, since it is possible to detect each reference mark even if there is no margin between adjacent image regions, it is possible to eliminate the margin. In this manner, the problem that the margin portion is wasted can be solved. In addition, since the medium itself can be reduced in size, it is possible to reduce the cost.

In addition, according to still another aspect of the present invention, there is provided a media cutting method including: determining a position of the boundary by performing the steps in the boundary determination method described above; and cutting the medium at a predetermined position calculated based on the position of the boundary. In this case, since it is possible to significantly reduce the time required until the cutting of each image region from the formation of reference marks, the tact time of processing can be greatly reduced. In addition, since the waste of the medium can be prevented, it is possible to reduce the cost.

According to the boundary determination method and the media cutting method described above, when determining the position of the boundary of each image region on the medium, it is possible to reduce both the time taken to form a reference mark on the medium and the time taken to detect the reference mark. Therefore, it is possible to greatly reduce the time required for the determination of the boundary position and the time required for the media cutting process based on the boundary position. In addition, since a margin portion of a medium to be processed can be eliminated when performing the media cutting process, the waste of the medium can be prevented. As a result, it is possible to reduce the cost.

### BRIEF DESCRIPTION OF THE DRAWINGS

FIG. 1 is a schematic perspective view showing an example of a cutting apparatus used when practicing a boundary determination method and a media cutting method according to an embodiment of the present invention.

FIG. 2 is a schematic front view (partially enlarged view) showing the configuration of a main part of the cutting apparatus shown in FIG. 1.

FIG. 3 is a control system diagram showing the configuration of the cutting apparatus shown in FIG. 1.

FIG. 4 is a flowchart showing the basic procedure of a boundary determination method and a media cutting method according to a first embodiment of the present invention.

FIG. 5 is an explanatory view for explaining the boundary determination method and the media cutting method according to the first embodiment of the present invention.

FIG. 6 is a flowchart showing the basic procedure of the boundary determination method and the media cutting method according to the first embodiment of the present invention.

FIG. 7 is a flowchart showing the basic procedure of the boundary determination method and the media cutting method according to the first embodiment of the present invention.

FIG. 8 is an explanatory view for explaining the boundary determination method and the media cutting method according to the first embodiment of the present invention.

FIG. 9 is an explanatory view for explaining a boundary determination method and a media cutting method according to a second embodiment of the present invention.

FIG. 10 is a flowchart showing the basic procedure of the boundary determination method and the media cutting method according to the second embodiment of the present invention.

FIG. 11 is a flowchart showing the basic procedure of the boundary determination method and the media cutting method according to the second embodiment of the present invention.

FIG. 12 is an explanatory view for explaining a boundary determination method and a media cutting method according to a third embodiment of the present invention.

FIG. 13 is an explanatory view for explaining a boundary determination method and a media cutting method according to a fourth embodiment of the present invention.

FIG. 14 is a flowchart showing the basic procedure of the boundary determination method and the media cutting method according to the fourth embodiment of the present invention.

FIG. 15 is a flowchart showing the basic procedure of the boundary determination method and the media cutting method according to the fourth embodiment of the present invention.

FIG. 16 is an explanatory view for explaining a boundary determination method and a media cutting method in the related art.

FIG. 17 is an explanatory view for explaining a boundary determination method and a media cutting method in the related art.

FIG. 18 is an explanatory view for explaining a boundary determination method and a media cutting method in the related art.

### DETAILED DESCRIPTION OF PREFERRED EMBODIMENTS

### First Embodiment

Hereinafter, a boundary determination method and a media cutting method according to a first embodiment of the present invention will be described in detail with reference to the accompanying diagrams. Here, an example of a cutting apparatus used when practicing the boundary determination method and media cutting method according to the present embodiment is shown in FIGS. 1 to 3.

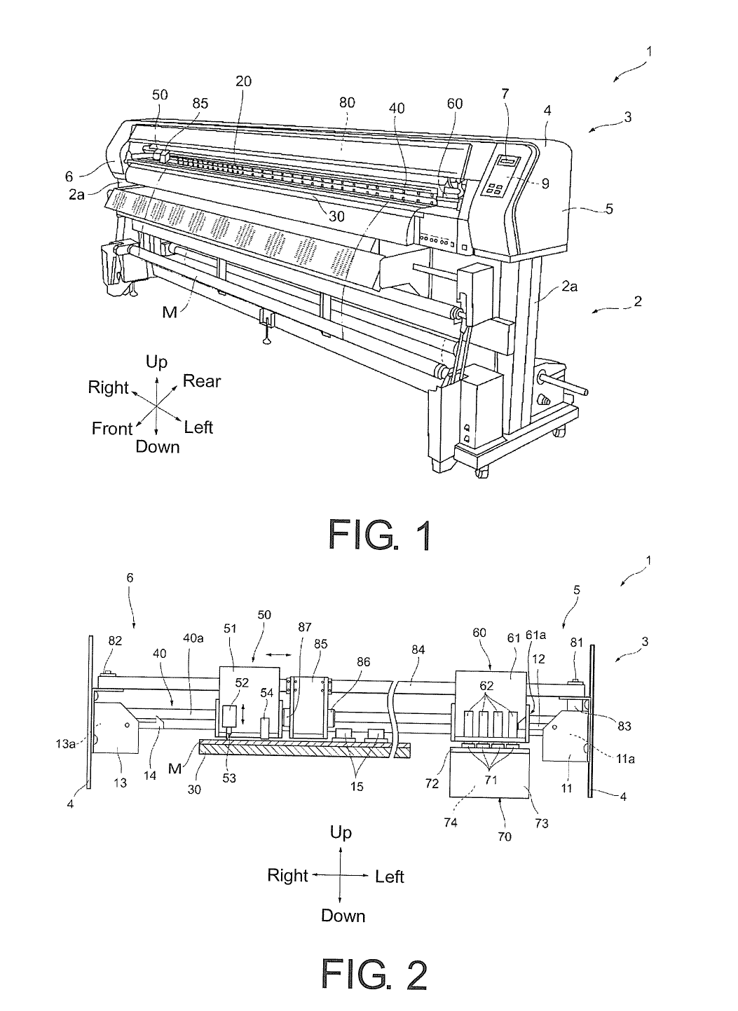

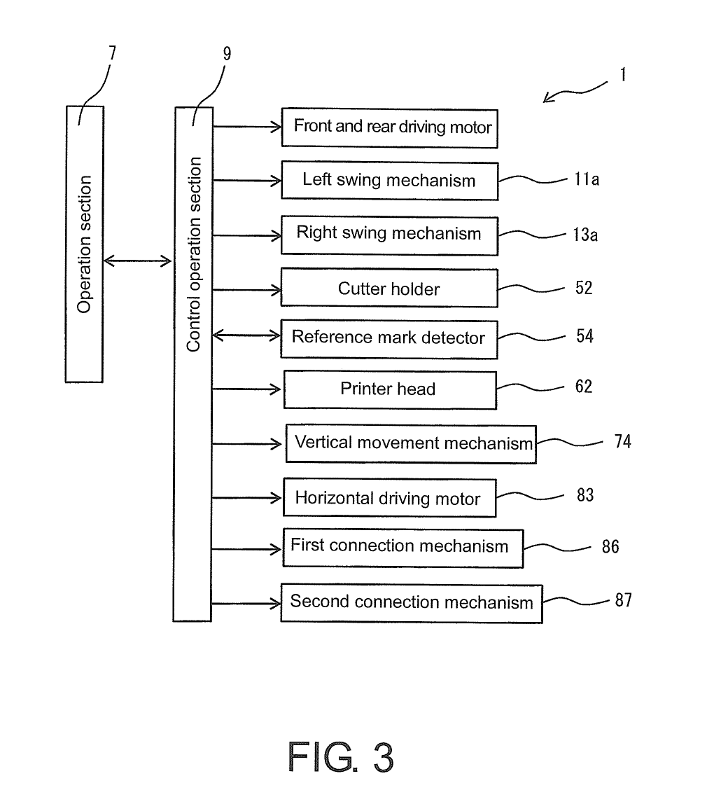

FIG. 1 is a schematic perspective view (schematic perspective view from the front direction) of a cutting apparatus 1 according to the present embodiment. In addition, FIG. 2 is a schematic front view (partially enlarged view) of a main part of the cutting apparatus 1. In addition, FIG. 3 is a control system diagram of the cutting apparatus 1. For convenience of explanation, front and rear direction, left and right direction, and up and down direction of the cutting apparatus 1 are indicated by arrow directions in each diagram.

In addition, in all diagrams for explaining the embodiment, components having the same functions are denoted by the same reference numerals, and repeated explanation thereof may be omitted.

As the cutting apparatus 1 used when practicing the boundary determination method and the media cutting method according to the present embodiment, a configuration including a cutting unit 50 that cuts a medium M while scanning the medium M and a printing unit 60 for printing on the medium M will be described as an example. However, the cutting apparatus is not limited to the above, and may be configured not to include the printing unit.

As shown in FIG. 1, the cutting apparatus 1 is configured to mainly include a support unit 2, which is formed by a pair of left and right support legs 2a, and a main body 3 that is supported by the support unit 2 and extends in a horizontal (left and right) direction. A left body unit 5 and a right body unit 6 are formed at the left and right ends of the main body 3, respectively, and peripheral portions thereof are covered with a main body cover 4. An operation section 7 including operation switches or display devices is provided on the front surface side of the left body unit 5. A control operation section 9 to which an operation signal from the operation section 7 is input is provided in the left body unit 5.

The control operation section 9 is electrically connected to each of components, which will be described later, and performs operation control of the components by outputting an operation signal thereto. Specifically, as shown in FIG. 3, the control operation section 9 controls the driving of a front and rear driving motor, driving of a left swing mechanism 11a, driving of a right swing mechanism 13a, vertical (up and down) movement of a cutter holder 52, discharge of ink from a printer head 62 (discharge nozzle), driving of a vertical movement mechanism 74, driving of a horizontal driving motor 83, connection by a first connection mechanism 86, and connection by a second connection mechanism 87. In addition, a receiving result of inspection light in a reference mark detector 54, which will be described later, is input to the control operation section 9.

A media feed mechanism 20, a platen 30 in which a region facing the printer head 62 is formed in the shape of a flat plate and which supports a medium M that is a printing and cutting target, a guide member 40 that is provided so as to extend in the horizontal direction above the platen 30 and guides a carriage (which will be described later) linearly in a main scanning direction (Y direction), the cutting unit 50, the printing unit 60, a maintenance unit 70, a unit driving device 80, and the like are provided between the left body unit 5 and the right body unit 6.

As shown in FIG. 2, the media feed mechanism 20 is configured to mainly include a plurality of rotatable pinch rollers 15 provided side by side below the guide member 40 and a feed roller (not shown) provided so as to protrude from the top surface of the platen 30 below the pinch rollers 15. The feed roller is rotated by a front and rear driving motor (not shown). Through this configuration, the medium M can be fed back and forth by a predetermined distance by rotating the feed roller by the front and rear driving motor in a state where the medium M is interposed between the feed roller and the pinch rollers 15.

As shown in FIG. 2, the cutting unit 50 is configured to mainly include a cutting carriage 51, the cutter holder 52, and the reference mark detector 54. The cutting carriage 51 is attached so as to be movable to the left and right with respect to a guide rail 40a formed on the front surface side of the guide member 40, and serves as a mounting base of the cutter holder 52 and the reference mark detector 54.

The cutter holder 52 is mounted so as to be movable up and down with respect to the cutting carriage 51, and a cutter blade 53 is detachably attached to the lower end of the cutter holder 52. The reference mark detector 54 includes a light emitting section (not shown) and a light receiving section (not shown) on its bottom surface. Reflected light of inspection light emitted toward the medium M from the light emitting section is received by the light receiving section. For example, the light receiving sensitivity of the light receiving section is set such that inspection light (inspection light with high intensity) is reflected and is received by the light receiving section on the surface of the medium M, on which printing is not performed, and inspection light is not reflected (inspection light with low intensity is reflected) in a portion where reference marks T1 to T4 to be described later are printed.

According to this configuration, a reference mark is detected by the reference mark detector 54, and then the boundary position is determined based on a reference point calculated from the reference mark. Then, by the media feed mechanism 20, the medium M is moved back and forth with respect to the platen 30, and the cutting carriage 51 is moved to the left and right in a state where the cutting edge of the cutter blade 53 provided at the bottom of the cutter holder 52 faces the surface of the medium M held by the platen 30. As a result, a predetermined position calculated from the boundary position of the medium M is cut.

The printing unit 60 is configured to mainly include a printing carriage 61 and a plurality of printer heads 62. Similar to the cutting carriage 51 described above, the printing carriage 61 is attached so as to be movable to the left and right with respect to the guide rail 40a, and serves as a mounting base of the printer heads 62. In addition, an engaging section 61a that is engageable with a left hook 12 to be described later is formed on the left surface of the printing carriage 61. The plurality of printer heads 62 correspond to colors of magenta, yellow, cyan, and black, for example. In addition, a plurality of discharge nozzles (not shown) from which ink is discharged downward are formed on the bottom surface of each printer head 62.

According to this configuration, by the media feed mechanism 20, the medium M is moved back and forth with respect to the platen 30, and the printing carriage 61 is moved to the left and right in a state where discharge nozzles of the printer head 62 face the surface of the medium M held by the platen 30. As a result, since ink is ejected from the discharge nozzles during the movement, desired characters or a desired pattern is printed on the surface of the medium M.

Here, the maintenance unit 70 is a device for performing maintenance of the printer head 62 here. As an example, the maintenance unit 70 is configured to include (four) suction caps 71 formed according to the shape of the bottom surface of each printer head 62, a stage 72 on which the suction caps 71 are mounted, a maintenance device body 73, and the vertical movement mechanism 74 provided in the maintenance device body 73.

In addition, the unit driving device 80 is configured to mainly include a driving pulley 81 and a driven pulley 82 provided so as to be located at the left and right ends of the guide member 40, the horizontal driving motor 83 for performing rotational driving of the driving pulley 81, a toothed driving belt 84 hung on both the pulleys 81 and 82, and a driving carriage 85 connected to the toothed driving belt 84 (refer to FIG. 2). The first connection mechanism 86 that connects the printing carriage 61 and the driving carriage 85 so as to be separable from each other is formed on the left surface side of the driving carriage 85. Similar to the first connection mechanism 86 described above, the second connection mechanism 87 that connects the cutting carriage 51 and the driving carriage 85 so as to be separable from each other is formed on the right surface side of the driving carriage 85. In addition, as the first and second connection mechanisms 86 and 87, it is possible to use a structure that makes a connection by engaging an engaging projection into a locking hole or a structure that makes a connection by using a magnetic property, for example.

Through this configuration, driving control of the horizontal driving motor 83 and the first and second connection mechanisms 86 and 87 is performed by the control operation section 9. Therefore, it is possible to perform control to move the cutting unit 50 or the printing unit 60 to the left and right along the guide rail 40a in a state where the cutting unit 50 or the printing unit 60 is connected to the driving carriage 85.

As shown in FIG. 2, a left hook support section 11 in which the left swing mechanism 11a is provided is fixed in the left body unit 5. The engaging section 61a of the printing carriage 61 can be engaged with the left hook 12 or the engagement can be released by swinging the left hook 12 up and down using the left swing mechanism 11a. On the other hand, a right hook support section 13 in which the right swing mechanism 13a is provided is fixed in the right body unit 6. Similar to the left hook support section 11 described above, the engaging section of the cutting carriage 51 can be engaged with a right hook 14 or the engagement can be released by swinging the right hook 14 up and down using the right swing mechanism 13a.

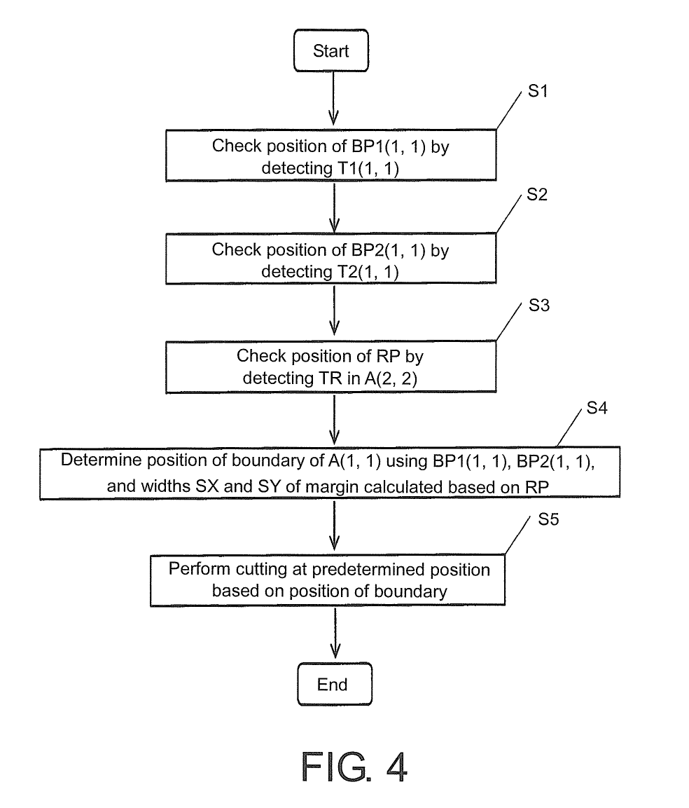

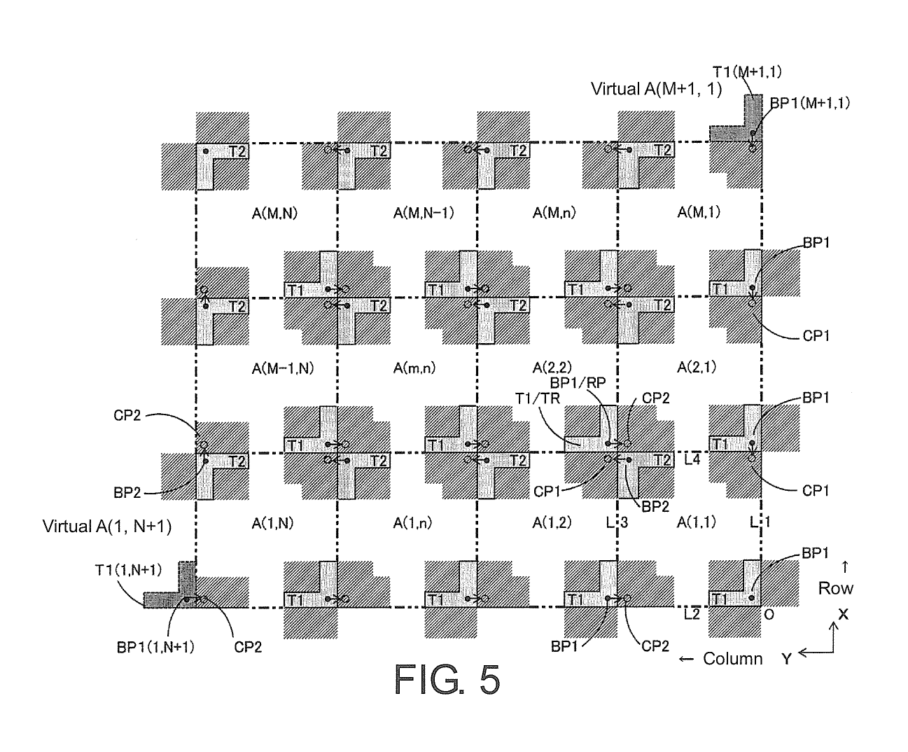

The configuration of the cutting apparatus 1 has been described hereinabove. Next, a boundary determination method for determining the position of the boundary on the medium M using the cutting apparatus 1 configured as described above and a media cutting method for cutting the medium M using the cutting apparatus 1 configured as described above will be described. Here, FIG. 4 is a flowchart showing the basic procedure of the boundary determination method and the media cutting method according to the present embodiment, and FIG. 5 is an explanatory view for explaining the boundary determination method and the media cutting method according to the present embodiment. In addition, shaded portions in FIG. 5 are regions where printing is prohibited (that is, regions where the printing of an image other than a reference mark is prohibited) in order to allow the detection of a reference mark (the same is true in the other diagrams).

In the following explanation, as shown in FIG. 5, a case where the position of the boundary of each image region is determined for the medium M on which a desired image or the like is formed in each predetermined image region and a reference mark (in the present embodiment, two reference marks T1 and T2) is formed (that is, printed in advance) at a predetermined position and cutting is performed at a predetermined cutting position, which is determined with the position of the boundary as a reference, will be given as an example. More specifically, a media cutting method for cutting each image region sequentially from a sheet-like medium, on which rectangular image regions having the same shape and size are arranged in a matrix of M rows and N columns (M and N are natural numbers) in X and Y directions will be described as an example.

In addition, images printed in the respective image regions may be the same image or different images. In addition, printing on the medium M may be performed using the cutting apparatus 1 (printing unit 60) according to the present embodiment, or may be performed using other printers or the like (not shown).

FIG. 5 shows a state where a predetermined position on the medium M is set as an origin O as a reference point and each image region A is arranged in a matrix of M rows in the X direction and N columns in the Y direction with the origin O as a starting point. For example, display may be performed such that an image region of the first row and first column is A(1, 1), an image region of the first row and second column is A(1, 2), and an image region of the m-th row and n-th column is A(m, n) (where, m and n are natural numbers, and 1≦m≦M and 1≦n≦N). In addition, the contour (boundary) of each image region is shown by the two-dot chain line in diagrams, but is not actually printed.

In the present embodiment, the medium M is prepared in which, in each image region A, a reference mark (first reference mark to be described later) is formed at a corner closest to the origin O and a reference mark (second reference mark to be described later) is formed at a diagonally opposite corner to the corner closest to the origin O (refer to FIG. 5). In addition, the origin O may be set at any position of the four corners of the medium M. For example, although the origin O is set at the right corner on the plane of FIG. 5 in the present embodiment, the procedure described below is the same even if the origin O is set at the left corner. Thus, it is preferable to form a reference mark near the outer edge, such as the corner of the medium M, as much as possible because it is possible to secure a wide printable region where intended printing is to be performed. Incidentally, when at least image regions are arranged in a matrix, reference marks are arranged at the same positions in the same shape and size.

First, an example (hereinafter, referred to as a “first example”) of the method of cutting the image region A(1, 1) of the first row and first column from the medium M will be described.

First, a process (step S1) of checking the position of a first reference point BP1 by detecting a reference mark, which is formed (printed in advance) at a corner closest to the origin O of the medium M, in the image region A(1, 1) of the first row and first column of the medium M is performed.

In addition, a reference mark, which is formed at a corner closest to the origin O of the medium M, in each image region A is referred to as a “first reference mark T1”. For example, the first reference mark T1 in the image region A(1, 1) is displayed as T1(1, 1).

In addition, a reference mark, which is formed at a diagonally opposite corner to the corner where the first reference mark T1 is formed, in each image region A is referred to as a “second reference mark T2”. For example, the second reference mark T2 in the image region A(1, 1) is displayed as T2(1, 1).

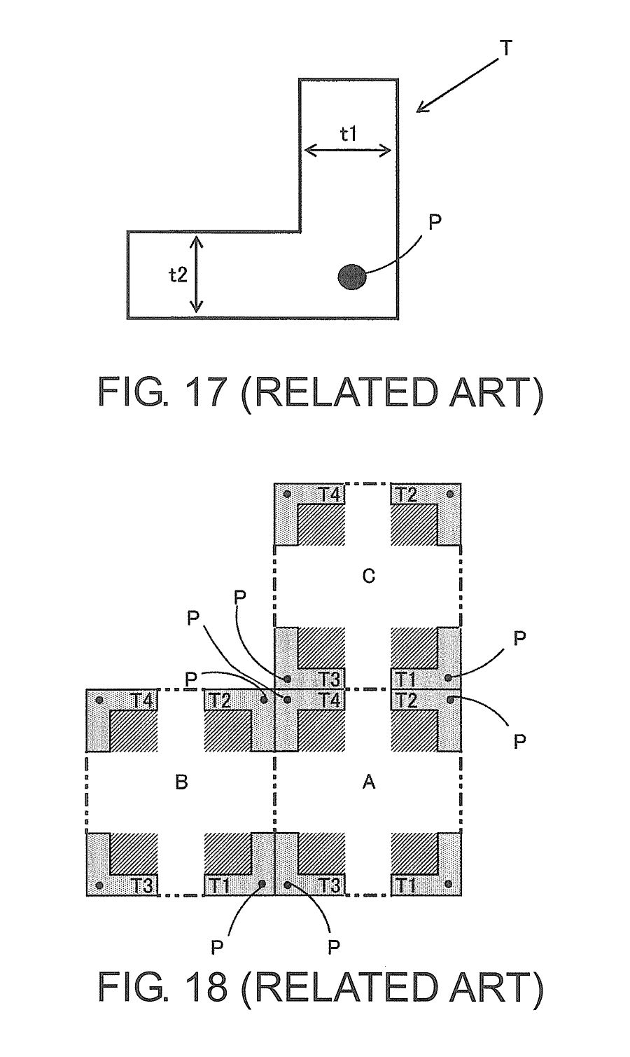

The reference mark (first and second reference marks T1 and T2) according to the present embodiment is formed in an L shape similar to the shape shown in FIG. 17 as an example. However, the shape of the reference mark is not limited to the L shape. For example, a rectangular shape or a circular shape may be adopted.

More specifically, in step S1, the medium M is disposed at a predetermined position so that a position where the first reference mark T1(1, 1) is formed on the medium M is immediately before the cutting carriage 51 to which the reference mark detector 54 is attached. Then, the detection of the first reference mark T1(1, 1) using the reference mark detector 54 is performed by moving the cutting carriage 51 in the left and right direction (Y direction) with respect to the guide rail 40a. Thus, a reference mark in the neighborhood in a main scanning direction (Y direction) is searched for by the movement of the cutting carriage 51. When there is no reference mark or when is not possible to detect a reference mark, a reference mark in the transport direction (X direction) of the medium M is searched for. This is because the positioning accuracy in the main scanning direction (Y direction) is higher than the positioning accuracy in the transport direction (X direction) of the medium M in general.

As described above, since the inspection light is not reflected in a portion where the reference mark is printed, the shape (specifically, edge (contour) shape) of the reference mark (here, the first reference mark T1(1, 1)) formed in the L shape can be detected from the receiving result of the inspection light in the light receiving section of the reference mark detector 54. In particular, the size and shape of t1 and t2 can be detected. In addition, the position of the first reference point BP1 as a reference point, which is set at a predetermined position within the first reference mark T1(1, 1), can be checked using the detection result. In addition, the first reference point BP1 within the first reference mark T1(1, 1) formed in the image region A(1, 1) is displayed as BP1(1, 1).

Then, a process (step S2) of checking the position of a second reference point BP2 by detecting the second reference mark T2, which is formed at a diagonally opposite corner to the corner where the first reference mark T1 is formed, in the image region A(1, 1) of the first row and first column is performed.

Step S2 may be performed in the same procedure as step S1 described above. In addition, the second reference point BP2 formed within the second reference mark T2(1, 1) in the image region A(1, 1) is displayed as BP2(1, 1).

Then, since it is not known whether or not there is a margin at this point in time, a process (step S3) of checking the position of a reference point RP for margin detection by detecting a reference mark TR for margin detection, which is formed at a corner closest to the origin O of the medium M, in the image region of the second row and second column of the medium M is performed. Details of the margin detection will be described later.

More specifically, in step S3, a first reference mark T1(2, 2) formed in the image region A(2, 2) of the second row and second column can also be used as the reference mark TR for margin detection. In addition, a first reference point BP1(2, 2) formed within the first reference mark T1(2, 2) can also be used as the reference point RP. Therefore, in step S3, the same process as step S1 for the image region A(1, 1) may be performed for the image region A(2, 2).

Thus, using the position information of the reference point RP and the position information of the second reference point BP2(1, 1), the control operation section 9 can calculate the X-direction width and the Y-direction width of the margin between the image region A(1, 1) and the image region A(2, 2). Even if the image region A(1, 1) and the image region A(2, 2) are set to be adjacent to each other without a gap theoretically, a margin may be generated between the image region A(1, 1) and the image region A(2, 2) in practice due to various causes, such as the occurrence of expansion and contraction in the medium M, a method of forming image data, and specifications of a printer used to form image data. Alternatively, a case may be assumed in which a margin is provided accidentally. Therefore, by calculating the margin, it is possible to perform position correction using the data of the margin when predicting the position of the prediction reference point (first prediction reference point, second prediction reference point, or the like).

As a specific method of calculating the margin, a margin in each direction can be calculated by detecting the position of the reference point RP and the position of the second reference point BP2(1, 1) and calculating how much the detected position is shifted from the theoretical position in the X and Y directions. Here, the width (size) of the calculated margin in the X direction is expressed as SX, and the width (size) of the calculated margin in the Y direction is expressed as SY.

In addition, although a method of determining a position, which is separated by a predetermined distance from the reference point (second reference point BP2(1, 1), first reference point BP1(2, 2), or the like), as a boundary position is adopted in the present embodiment, the present invention is not limited thereto. For example, it is possible to adopt a method of determining the middle position of the margin width SX and SY as a boundary position using the margin calculated as described above.

By including the process of step S3 described above, even if a margin is present around the image region A, it is possible to determine the boundary position accurately and in a shorter time than in the method of forming and detecting a reference mark at four corners of the image region as illustrated in JP 2011-051192 A, in a boundary position determination process to be described below. In addition, an effect is obtained that media can be effectively used by reducing the margin while ensuring the printable region (portion excluding a drawing data prohibited region from the image region).

Then, a process (step S4) of determining the position (here, illustrated as a position indicated by the two-dot chain line in FIG. 5) of the boundary in the image region A(1, 1) of the first row and first column using the position information of the first reference point BP1(1, 1), the position information of the second reference point BP2(1, 1), and the shape (size) information of the X-direction width SX and the Y-direction width SY of the margin adjacent to the image region A(1, 1) of the first row and first column calculated using the reference point RP for margin detection, all of which have been obtained by the process up to now, is performed.

More specifically, in step S4, the control operation section 9 can calculate the position of the boundary in the image region A(1, 1) of the first row and first column, that is, the positions of the sides L1, L2, L3, and L4, which are shown by the two-dot chain line that surrounds the image region A(1, 1) in FIG. 5 in a rectangular shape, using the position information of the first reference point BP1(1, 1) and the position information of the second reference point BP2(1, 1). Since the influence of the expansion and contraction of the medium M can be fed back by performing a correction using the shape (size) information of the X-direction width SX and the Y-direction width SY of the margin, it is possible to dramatically increase the accuracy of the calculated boundary position. Therefore, it is possible to perform the boundary position determination and cutting process more accurately.

As described above, the boundary determination method according to the present embodiment is performed.

Then, a process (step S5) of cutting the image region A(1, 1) of the first row and first column based on the boundary positions L1, L2, L3, and L4 is performed. In addition, in the present embodiment, a case where the boundary positions L1, L2, L3, and L4 are set as cutting positions will be described as an example. However, predetermined positions calculated based on the boundary positions L1, L2, L3, and L4 may be set as cutting positions, without being limited to the above example.

More specifically, in step S5, the control operation section 9 controls each driving mechanism based on the position information of the boundary obtained in step S4 to move the medium M back and forth with respect to the platen 30 and move the cutting carriage 51 to the left and right, thereby cutting the medium M at a predetermined cutting position (in the present embodiment, the position of the boundary described above as an example).

As described above, the media cutting method according to the present embodiment is performed.

Next, another example (hereinafter, referred to as a “second example”) of the method of cutting the image region A(1, 1) of the first row and first column from the medium M will be described.

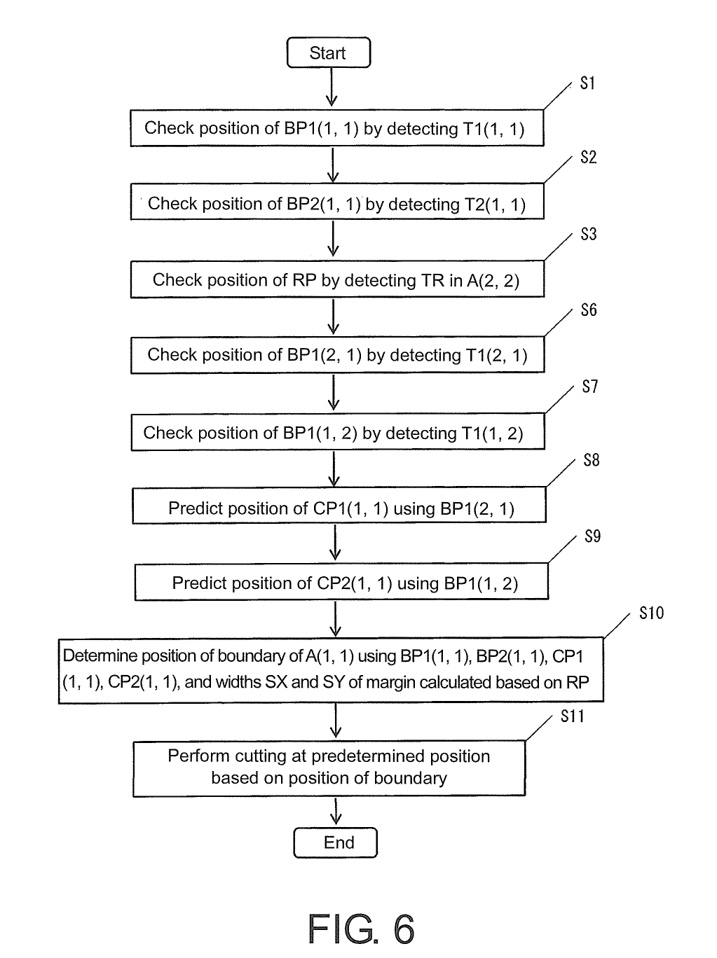

In the second example, the process of steps S1 to S3 is the same as in the first example. The difference between the first and second examples is that steps S6 to S11 shown below are performed instead of the process of steps S4 and S5 in the first example. FIG. 6 is a flowchart showing the basic procedure of the second example.

First, step S6 will be described.

As a step S6, a process of checking the position of a first reference point BP1(2, 1) (corresponding to a “third reference point” described in the appended claims) within the reference mark by detecting a first reference mark T1(2, 1) (corresponding to a “third reference mark” described in the appended claims), which is formed at a corner closest to the origin O of the medium M, in the image region A(2, 1) of the second row and first column of the medium M is performed.

More specifically, in step S6, the same process as step S1 for the image region A(1, 1) described in the first example may be performed for the image region A(2, 1).

Then, a process (step S7) of checking the position of a first reference point BP1(1, 2) (corresponding to a “fourth reference point” described in the appended claims) within the reference mark by detecting a first reference mark T1(1, 2) (corresponding to a “fourth reference mark” described in the appended claims), which is formed at a corner closest to the origin O of the medium M, in the image region A(1, 2) of the first row and second column of the medium M is performed.

More specifically, in step S7, the same process as step S1 for the image region A(1, 1) described in the first example may be performed for the image region A(1, 2).

Then, at a corner in the image region A(1, 1) of the first row and first column that is adjacent to a corner where the first reference mark T1(2, 1) (“third reference mark”) is formed in the image region A(2, 1) of the second row and first column, a process (step S8) of predicting the position of a first prediction reference point CP1 using the first reference point BP1(2, 1) (“third reference point”) in the image region A(2, 1) of the second row and first column is performed. In addition, the first prediction reference point CP1 whose position in the image region A(1, 1) has been predicted is expressed as CP1(1, 1).

More specifically, in step S8, the control operation section 9 calculates a predetermined position of a corner in the image region A(1, 1) adjacent to the formation position of the first reference mark T1(2, 1) (“third reference mark”) in the image region A(2, 1), as the first prediction reference point CP1(1, 1) in the image region A(1, 1), using the position information of the first reference point BP1(2, 1) (“third reference point”) in the image region A(2, 1) of the second row and first column.

As a specific calculation method, a position that is separated by a predetermined distance in a predetermined direction (here, X direction) from the position of the first reference point BP1(2, 1) (“third reference point”) in the image region A(2, 1) is determined by calculation, and the position is calculated as the first prediction reference point CP1(1, 1) in the image region A(1, 1).

Then, at a corner in the image region A(1, 1) of the first row and first column that is adjacent to a corner where the first reference mark T1(1, 2) (“fourth reference mark”) is formed in the image region A(1, 2) of the first row and second column, a process (step S9) of predicting the position of a second prediction reference point CP2 using the first reference point BP1(1, 2) (“fourth reference point”) in the image region A(1, 2) of the first row and second column is performed. In addition, the second prediction reference point CP2 whose position in the image region A(1, 1) has been predicted is expressed as CP2(1, 1).

More specifically, in step S9, the control operation section 9 calculates a predetermined position of a corner in the image region A(1, 1) adjacent to the formation position of the first reference mark T1(1, 2) (“fourth reference mark”) in the image region A(1, 2), as the second prediction reference point CP2(1, 1) in the image region A(1, 1), using the position information of the first reference point BP1(1, 2) (“fourth reference point”) in the image region A(1, 2) of the first row and second column.

As a specific calculation method, a position that is separated by a predetermined distance in a predetermined direction (here, Y direction) from the position of the first reference point BP1(1, 2) (“fourth reference point”) in the image region A(1, 2) is determined by calculation, and the position is calculated as the second prediction reference point CP2(1, 1) in the image region A(1, 1).

In addition, the execution procedure of steps S6 to S9 is not limited to the above, and the above procedure may be performed in order of steps S6, S8, S7, and S9, in order of steps S7, S6, S9, and S8, or in order of steps S7, S9, S6, and S8.

Then, a process (step S10) of determining the position (here, illustrated as a position indicated by the two-dot chain line in FIG. 5) of the boundary in the image region A(1, 1) of the first row and first column using the position information of the first reference point BP1(1, 1), the position information of the second reference point BP2(1, 1), the position information of the first prediction reference point CP1(1, 1), the position information of the second prediction reference point CP2(1, 1), and the shape (size) information of the X-direction width SX and the Y-direction width SY of the margin adjacent to the image region A(1, 1) of the first row and first column calculated using the reference point RP for margin detection, all of which have been obtained by the process up to now, is performed.

More specifically, in step S10, the control operation section 9 can calculate the position of the boundary in the image region A(1, 1) of the first row and first column, that is, the positions of the sides L1, L2, L3, and L4, which are shown by the two-dot chain line in FIG. 5, using the position information of the first reference point BP1(1, 1), the position information of the second reference point BP2(1, 1), the position information of the first prediction reference point CP1(1, 1), and the position information of the second prediction reference point CP2(1, 1).

In the first example described above, the boundary position is calculated using the position information of two points and the information of the margin. In the second example, however, the boundary position is calculated using the position information (the first reference point BP1, the second reference point BP2, the first prediction reference point CP1, and the second prediction reference point CP2) of four points (four corners) and the information of the margin. Therefore, it is possible to further increase the calculation accuracy. In particular, even when not only a margin but also skew is present in the medium M, it is possible to calculate the boundary position with high accuracy. Therefore, it is possible to perform the boundary position determination and cutting process more accurately than in the first example.

As described above, the boundary determination method according to the present embodiment is performed.

Then, a process (step S11) of cutting the image region A(1, 1) of the first row and first column based on the boundary positions L1, L2, L3, and L4 is performed.

More specifically, step S11 is the same process as step S5 in the first example described above.

As described above, the media cutting method according to the present embodiment is performed.

Examples (first and second examples) of the method of cutting the image region A(1, 1) of the first row and first column from the medium M have been described hereinabove.

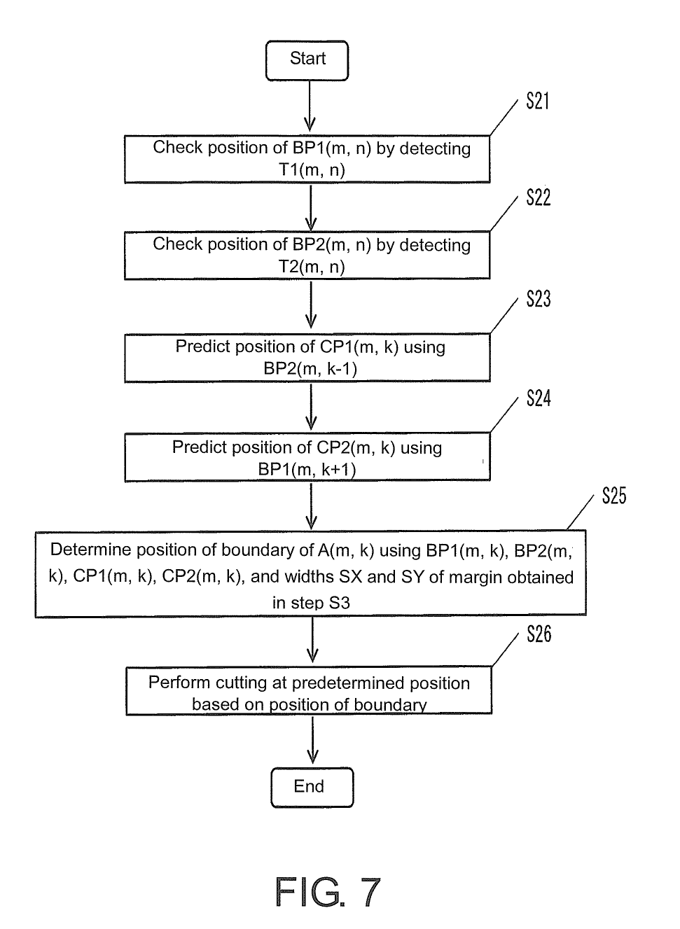

Next, an example of the method of cutting an image region A(m, k) of the m-th row and k-th column from the medium M will be described. Here, a case of k=n+1 (2≦k≦N−1) will be described. That is, the process shown below is a process performed after carrying out the first example or the second example. FIG. 7 is a flowchart showing the basic procedure.

First, a process (step S21) of checking the position of a first reference point BP1(m, n) by detecting a first reference mark T1(m, n), which is formed (printed in advance) at a corner closest to the origin O of the medium M, in each image region A(m, n) of the m-th row and n-th column (1≦m≦M, 1≦n≦N) of the medium M is performed.

More specifically, in step S21, the same process as step S1 for the image region A(1, 1) described above may be sequentially performed for each image region A(m, n). In addition, since the process for the image region A(1, 1) has already been performed in step S1, the process for the image region A(1, 1) does not need to be repeatedly performed.

Then, a process (step S22) of checking the position of a second reference point BP2(m, n) by detecting the second reference mark T2(m, n), which is formed at a diagonally opposite corner to the corner where the first reference mark T1(m, n) is formed, in each image region A(m, n) of the m-th row and n-th column (1≦m≦M, 1≦n≦N) of the medium M is performed.

More specifically, in step S22, the same process as step S2 for the image region A(1, 1) described above may be sequentially performed for each image region A(m, n). In addition, since the process for the image region A(1, 1) has already been performed in step S2, the process for the image region A(1, 1) does not need to be repeatedly performed.

Then, at a corner in each image region A(m, k) of the m-th row and k-th column of the medium M that is adjacent to a corner where the second reference mark T2(m, k−1) is formed in the image region A(m, k−1) of the m-th row and (k−1)-th column, a process (step S23) of predicting the position of a first prediction reference point CP1(m, k) using the second reference point BP2(m, k−1) in the image region of the m-th row and (k−1)-th column is performed. Here, k=n+1 and 2≦k≦N−1 are assumed (the same hereinbelow).

More specifically, in step S23, the control operation section 9 calculates a predetermined position of a corner in the image region A(m, k) of the m-th row and k-th column adjacent to the formation position of the second reference mark T2(m, k−1) in the image region A(m, k−1), as the first prediction reference point CP1(m, k) in the image region A(m, k), using the position information of the second reference point BP2(m, k−1) in the image region A(m, k−1) of the m-th row and (k−1)-th column obtained in step S22.

As a specific calculation method, a position that is separated by a predetermined distance in a predetermined direction (here, Y direction) from the position of the second reference point BP2(m, k−1) in the image region A(m, k−1) is determined by calculation, and the position is calculated as the first prediction reference point CP1(m, k) in the image region A(m, k).

Then, at a corner in each image region A(m, k) of the m-th row and k-th column of the medium M that is adjacent to a corner where the first reference mark T1(m, k+1) is formed in the image region A(m, k+1) of the m-th row and (k+1)-th column, a process (step S24) of predicting the position of a second prediction reference point CP2(m, k) using the first reference point BP1(m, k+1) in the image region A(m, k+1) of the m-th row and (k+1)-th column is performed.

More specifically, in step S24, the control operation section 9 calculates a predetermined position of a corner in the image region A(m, k) of the m-th row and k-th column adjacent to the formation position of the first reference mark T1(m, k+1) in the image region A(m, k+1), as the second prediction reference point CP2(m, k) in the image region A(m, k), using the position information of the first reference point BP1(m, k+1) in the image region A(m, k+1) of the m-th row and (k+1)-th column obtained in step S21. In addition, step S24 is the same process as step S9 in the second example described above.

As a specific calculation method, a position that is separated by a predetermined distance in a predetermined direction (here, Y direction) from the position of the first reference point BP1(m, k+1) in the image region A(m, k+1) is determined by calculation, and the position is calculated as the second prediction reference point CP2(m, k) in the image region A(m, k).

As the procedure of steps S21 to S24, steps S21 to S24 may be sequentially performed for each image region A(m, k), or steps S21 to S24 may be sequentially performed for all image regions A(m, k), or steps S21 to S24 may be sequentially performed for the image region A(m, k) in units of each row and each column. Thus, various kinds of procedures can be considered.

In addition, as in step S24, when predicting the position of the prediction reference point (here, the second prediction reference point CP2(m, k)), it is preferable to perform the position prediction using the reference point (here, the first reference point BP1(m, k+1)) of the image region A adjacent in the Y direction. This is because control and operation in the case of a scan in the Y direction by the movement of the carriage can be performed more accurately than that in the case of a scan in the X direction in which media transport is performed. This is the same for other processes (process of predicting the position of a reference point).

However, when there is no reference point in the Y direction or when the reference point in the Y direction cannot be detected, it is preferable to perform prediction using the reference point of the image region A adjacent in the X direction.

In addition, from the relationship among the movement accuracy of the cutting apparatus 1 in the X and Y directions, the characteristics of the medium M, and the like, a reference point of a reference mark in an image region distant to some extent that is not an adjacent image region can also be used as a reference to predict the position of the prediction reference point. However, predicting the position of the prediction reference point using a reference point of a reference mark in the closest (that is, adjacent) image region is advantageous since it is possible to increase the accuracy of prediction (position determination) most and to shorten the processing time most.

Then, a process (step S25) of determining the position (here, illustrated as positions L1 to L4 shown by the two-dot chain line that surrounds each image region A(m, k) in FIG. 5 in a rectangular shape; however, reference numerals are denoted only around the image region A(1, 1) for simplification of diagrams, and reference numeral description is similarly omitted around the other image region A(m, k)) of the boundary in the image region A(m, k) of the m-th row and k-th column using the position information of the first reference point BP1(m, k), the position information of the second reference point BP2(m, k), the position information of the first prediction reference point CP1(m, k), the position information of the second prediction reference point CP2(m, k), and the shape (size) information of the X-direction width SX and the Y-direction width SY of the margin obtained as correction data in step S3, all of which have been obtained by the process up to now, is performed.

More specifically, step S25 is the same process as step S10 in the second example described above.

As described above, the boundary determination method according to the present embodiment is performed.

Then, a process (step S26) of cutting the image region A(m, k) of the m-th row and k-th column based on the boundary position calculated in step S25 is performed. In addition, as the procedure, it is assumed that the boundary determination (step S25) and the cutting (step S26) are continuously performed for each image region A(m, k). In this case, the amount of movement of the cutting carriage 51 (reference mark detector 54) and the medium M is reduced in the boundary determination process to the cutting process for each image region A. Therefore, an effect is obtained that the process of determining the boundary of the image region and the process of cutting the image region can be performed with high accuracy. However, it is possible to perform the process (step S25) of determining the boundary for all image regions A(m, k) and then perform the process (step S26) of cutting the image regions A(m, k) sequentially without being limited to the above procedure.

More specifically, step S26 is the same process as steps S5 and S11 described above.

As described above, the media cutting method according to the present embodiment is performed.

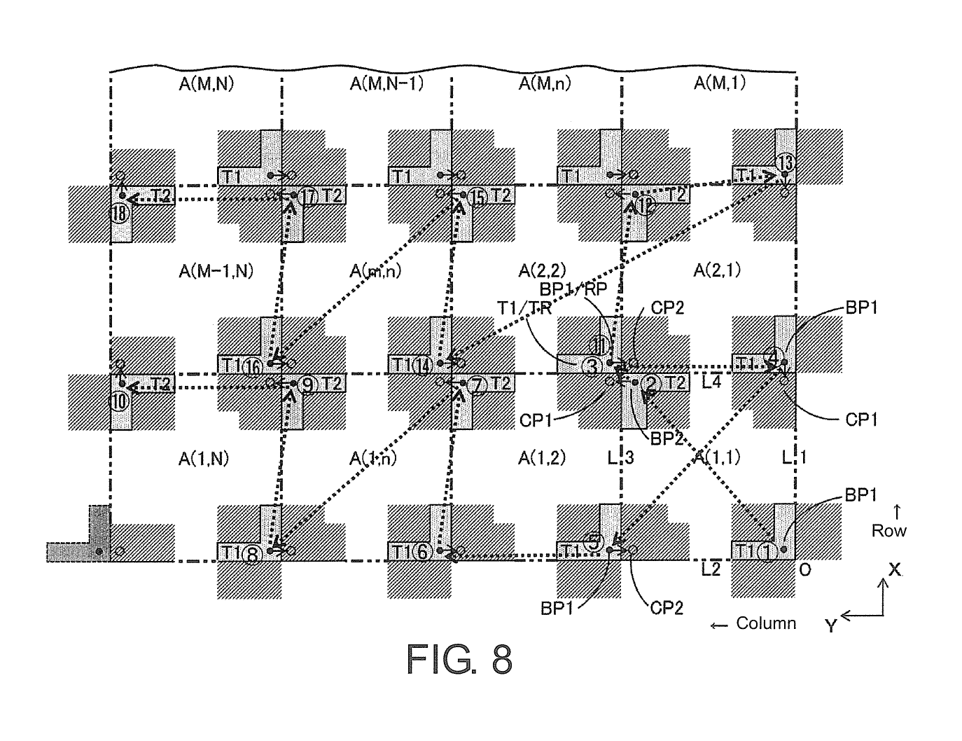

FIG. 8 shows an example of a procedure of detecting and calculating (predicting) the position of each reference point to specify it. As shown in FIG. 8, it is preferable to specify the position of each reference point in the order of circled numbers (in addition, circled numbers 3 and 11 are the same position). However, various procedures can be adopted by changing the setting position of the origin O, for example, without being limited to the above example.

In addition, since the above-described process may not be able to be applied as it is depending on the position of the image region A, the following exceptional process (steps ES1, ES2, ES3, and ES4) is performed (not shown).

For an image region A(m, 1) (where, 2≦m≦M−1) in the second example, as a process of predicting a first prediction reference point CP1(m, 1) (step ES1), the same process as step S8 may be performed. Specifically, the control operation section 9 calculates a predetermined position of a corner in the image region A(m, 1) adjacent to the formation position of the first reference mark T1(m+1, 1) in the image region A(m+1, 1), as the first prediction reference point CP1(m, 1) in the image region A(m, 1), using the position information of the first reference point BP1(m+1, 1) in the image region A(m+1, 1).

For an image region A(M, 1) in the second example, as a process of predicting the first prediction reference point CP1(m, 1) (step ES2), the same process as step S8 may be performed after calculating a first reference point BP1(M+1, 1) in an image region A(M+1, 1) assumed as a virtual image region. Specifically, for example, the control operation section 9 calculates the first reference mark T1(M+1, 1) in the virtual image region A(M+1, 1) by appropriately using the position information of the first reference point BP1(M, 1) in the image region A(M, 1), the position information of the first reference point BP1(M−1, 1) in the image region A(M−1, 1), the position information of the first reference point BP1(M−2, 1) in the image region A(M−2, 1), and the like. Then, the position of the first reference point BP1(M+1, 1) in the calculated first reference mark T1(M+1, 1) is calculated. Then, similar to step S8, a predetermined position of a corner in the image region A(M, 1) adjacent to the position of the first reference mark T1(M+1, 1) is calculated as the first prediction reference point CP1(M, 1) in the image region A(M, 1) using the position information of the first reference point BP1(M+1, 1).

For an image region A(1, N) in the second example, as a process of predicting a second prediction reference point CP2(1, N) (step ES3), the same process as step S9 may be performed after calculating a first reference point BP1(1, N+1) in an image region A(1, N+1) assumed as a virtual image region. Specifically, for example, the control operation section 9 calculates the first reference mark T1(1, N+1) in the virtual image region A(1, N+1) by appropriately using the position information of the first reference point BP1(1, N) in the image region A(1, N), the position information of the first reference point BP1(1, N−1) in the image region A(1, N−1), the position information of the first reference point BP1(1, N−2) in the image region A(1, N−2), and the like. Then, the position of the first reference point BP1(1, N+1) in the calculated first reference mark T1(1, N+1) is calculated. Then, similar to step S9, a predetermined position of a corner in the image region A(1, N) adjacent to the position of the first reference mark T1(1, N+1) is calculated as the second prediction reference point CP2(1, N) in the image region A(1, N) using the position information of the first reference point BP1(1, N+1).

For an image region A(m, N) (where, 2≦m≦M) in the second example, as a process of predicting a second prediction reference point CP2(m, N) (step ES4), a prediction process using the second reference point BP2(m−1, N) in the image region A(m−1, N) may be performed. Specifically, the control operation section 9 calculates a predetermined position of a corner in the image region A(m, N) adjacent to the formation position of the second reference mark T2(m−1, N) in the image region A(m−1, N), as the second prediction reference point CP2(m, N) in the image region A(m, N), using the position information of the second reference point BP2(m−1, N) in the image region A(m−1, N).

The exceptional process described above can also be applied when there is a blank region in image regions arranged in a matrix, for example. That is, for the medium M on which the image regions A are arranged in a matrix used in the description in the present embodiment, only a case where all image regions are arranged adjacent to each other without a gap on the medium is not necessarily assumed. In practice, a case in which a smaller number of image regions than the number of columns are arranged in a row (case in which there is a blank region) or the like is also considered. Also in such a case, for a portion in which image regions are arranged adjacent to each other without a gap, it is possible to apply the basic process (steps S1 to S26). In addition, for a portion in which image regions of the same number of columns are not arranged in a row, the exceptional process (may be appropriately selected from steps ES1 to ES4) is performed. In this manner, it is possible to perform the boundary determination process and the cutting process for the entire medium M.

Next, the characteristic configuration of the boundary determination method extracted from the above embodiment will be described.

That is, the boundary determination method for determining the position of the boundary of the first and second image regions arranged on the medium is based on the configuration including: a detection process (for example, steps S3, S6, and S7) for checking the position information of the first image region by detecting the reference mark that is formed (printed in advance) in the first image region in order to indicate the position of the first image region; a prediction process (for example, steps S8 and S9) for predicting the position information in the second image region based on the position information of the first image region; and a determination process (for example, steps S4 and S10) for determining the position of the boundary based on the positional relationship between the first and second image regions calculated using the position information of the first and second image regions obtained in the detection process and the prediction process. In particular, the boundary determination method includes the prediction process. Therefore, since a larger amount of position information (a larger number of reference points and prediction reference points) than the amount of information of positions (reference points) actually formed can be used when performing the determination process, it is possible to increase the accuracy of boundary determination (calculation).

In addition, when the first and second image regions are image regions having the same shape and size that are arranged adjacent to each other on the medium, a process of predicting the position information of the second image region using the position information and shape information of the first image region (shape of the image region itself) and the shape information of the second image region is included. Therefore, it is possible to further increase the accuracy of boundary determination (calculation).

Accordingly, as illustrated in the above embodiment, an effect is obtained that, when the first and second image regions are two adjacent image regions of a plurality of rectangular image regions arranged in a matrix on the medium, the process of predicting the position information of the second image region can be realized by a simple calculation method of translating the position information of the first image region.

As described above, in the boundary determination method and the media cutting method according to the present embodiment, it is possible to perform boundary determination and cutting by forming only two reference marks (here, T1 and T2) in each image region A on the medium M that is a target to be cut. Therefore, it is possible to greatly reduce the time required to form (print) the reference marks T1 and T2 (for example, reduced to the half or less of the time in the method disclosed in JP 2011-051192 A), and it is also possible to greatly reduce the time required to detect the reference marks T1 and T2 (for example, reduced to the half or less of the time in the method disclosed in JP 2011-051192 A). Thus, since it is possible to significantly reduce the time required until the cutting of each image region A from the formation of the reference marks T1 and T2, the tact time of processing can be greatly reduced. As a result, it is possible to improve the processing efficiency.

In addition, since only two reference marks T1 and T2 may be formed at diagonal positions in each image region A on the medium M, it is possible to realize a configuration in which the reference marks T1 and T2 in the adjacent image regions A are not arranged adjacent to each other. That is, since it is possible to detect the reference marks T1 and T2 even if there is no margin between the adjacent image regions A, it is possible to perform the determination of a boundary position and the cutting of a predetermined position set based on the boundary position. Therefore, since it is possible to eliminate the margin between the adjacent image regions, which is required for the practice of the known method illustrated in JP 2011-051192 A, it is possible to solve the problem that a margin portion of the medium M is wasted. In addition, since the medium itself can be reduced in size, it is possible to reduce the cost.

### Second Embodiment

Next, a boundary determination method and a media cutting method according to a second embodiment of the present invention will be described.

The boundary determination method and the media cutting method according to the second embodiment and the cutting apparatus 1 used therein are basically the same as those in the first embodiment (second example) described above, but there is a difference particularly in the position of a reference mark. Hereinafter, the present embodiment will be described focusing on the difference.

In addition, repeated explanation regarding the same configuration, operations and effects, and the like as in the boundary determination method and the media cutting method according to the first embodiment may be omitted.

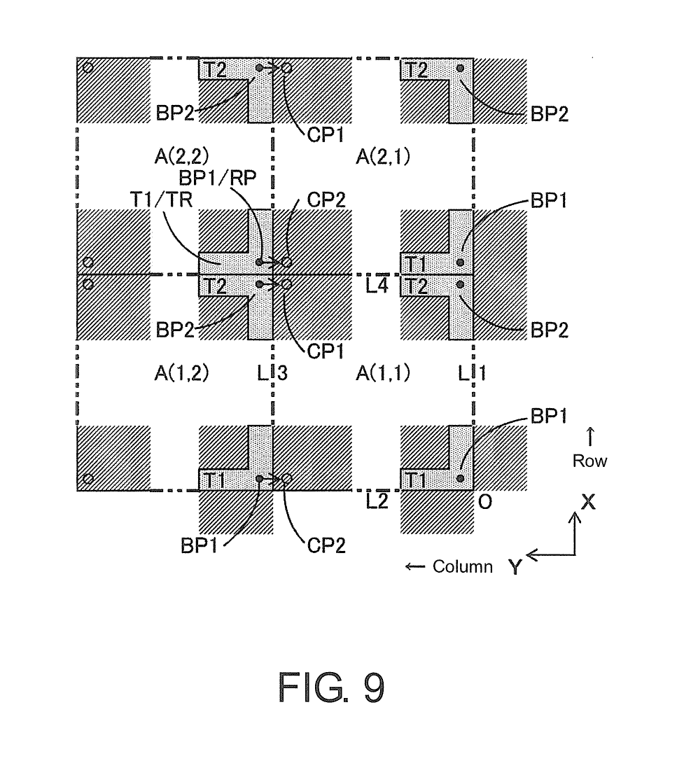

In the present embodiment, the medium M is prepared in which, in each image region A, a reference mark (first reference mark T1) is formed at a corner closest to the origin O and a reference mark (second reference mark T2) is formed at a corner aligned in the X direction with the corner closest to the origin O (refer to FIG. 9).

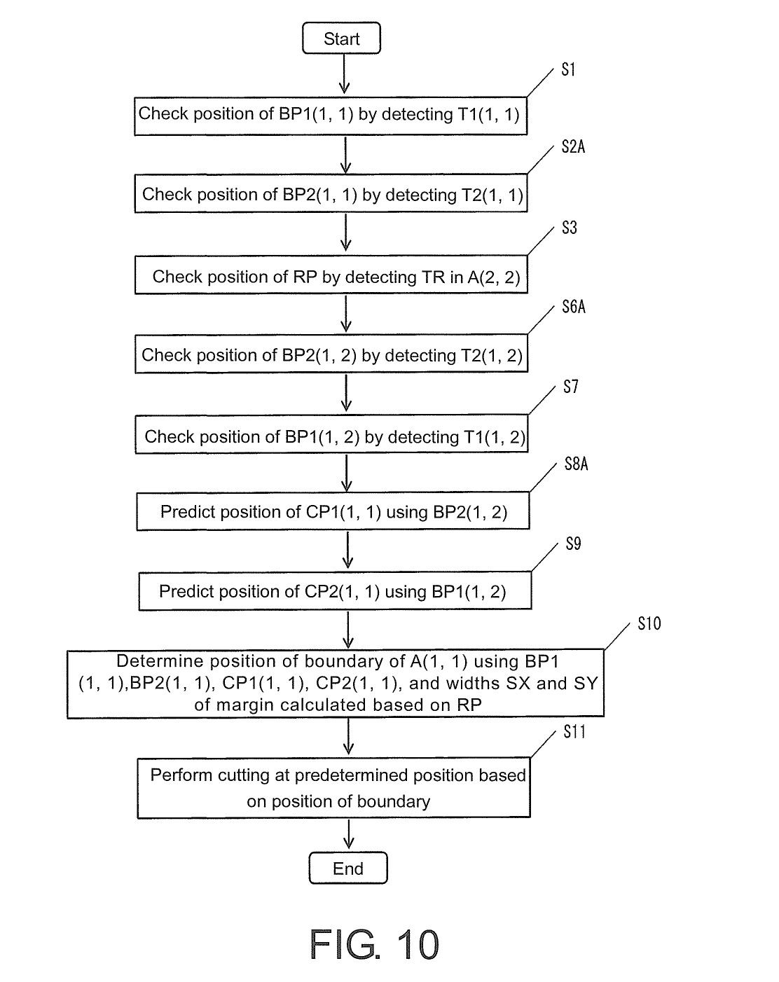

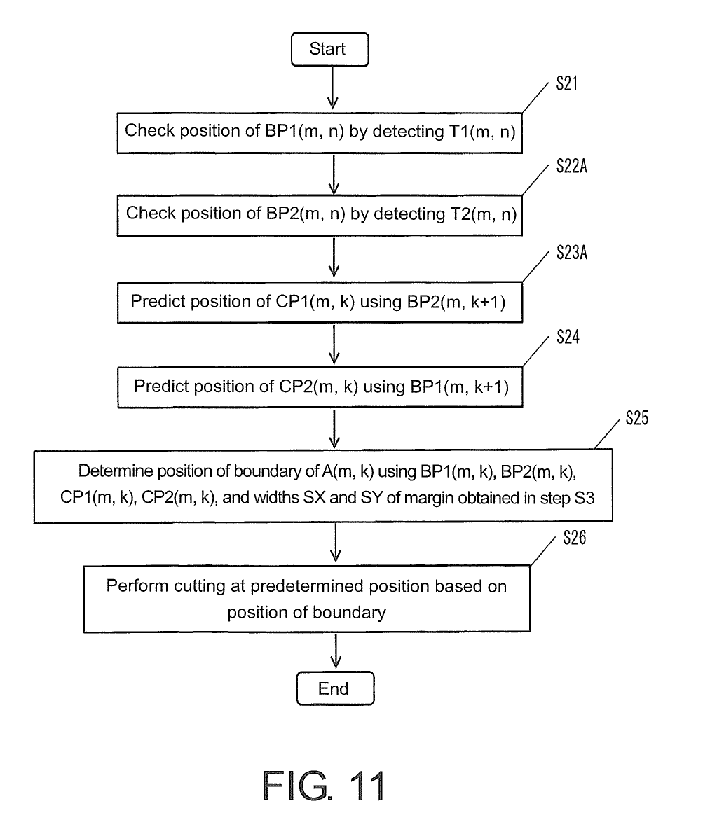

First, an example of the method of cutting the image region A(1, 1) of the first row and first column from the medium M will be described. FIGS. 10 and 11 are flowcharts showing the basic procedures of the boundary determination method and the media cutting method according to the present embodiment.

First, a process of checking the position of the first reference point BP1(1, 1) by detecting the first reference mark T1(1, 1), which is formed (printed in advance) at a corner closest to the origin O of the medium M, in the image region A(1, 1) of the first row and first column of the medium M is performed. This process is the same process as step S1 described above.

Then, a process (step S2A) of checking the position of the second reference point BP2(1, 1) by detecting the second reference mark T2(1, 1), which is formed at a corner aligned in the X direction with the corner where the first reference mark T1(1, 1) is formed, in the image region A(1, 1) of the first row and first column is performed. In addition, the method of detection and position checking may be performed in the same manner as in step S2 described above.

Then, a process of checking the position of the reference point RP for margin detection by detecting the reference mark TR for margin detection, which is formed at a corner closest to the origin O of the medium M, in the image region A(2, 2) of the second row and second column of the medium M is performed. This is different from the first embodiment described above in that the position of the second reference point BP2(1, 1) is formed at a corner that is not a corner closest to the position of the reference point RP, but the above can be performed by the same process as step S3 described above. Thus, it is possible to calculate the X-direction width SX and the Y-direction width SY of the margin between the image region A(1, 1) and the image region A(2, 2).

Then, a process (step S6A) of checking the position of a second reference point BP2(1, 2) (corresponding to the “third reference point” described in the appended claims) within the reference mark by detecting a second reference mark T2(1, 2) (corresponding to the “third reference mark” described in the appended claims) in the image region A(1, 2) of the first row and second column of the medium M is performed. In addition, the method of detection and position checking may be performed in the same manner as in step S7 described above.

Then, a process (step S7) of checking the position of the first reference point BP1(1, 2) (corresponding to the “fourth reference point” described in the appended claims) within the reference mark by detecting the first reference mark T1(1, 2) (corresponding to the “fourth reference mark” described in the appended claims) in the image region A(1, 2) of the first row and second column of the medium M, which is formed at a corner closest to the origin O of the medium M, is performed. This process is the same process as step S7 described above.

Any one of steps S6A and S7 may be performed first.

Then, at a corner in the image region A(1, 1) of the first row and first column that is adjacent to a corner where the second reference mark T2(1, 2) (“third reference mark”) is formed in the image region A(1, 2) of the first row and second column, a process (step S8A) of predicting the position of the first prediction reference point CP1(1, 1) using the second reference point BP2(1, 2) (“third reference point”) in the image region A(1, 2) of the first row and second column is performed. In addition, the method of detection and position checking may be performed in the same manner as in step S9 described above.

Then, the same processes as steps S9 and S10 described above are sequentially performed.

As described above, the boundary determination method according to the present embodiment is performed.

Then, the same process as step S 11 described above is performed.

As described above, the media cutting method according to the present embodiment is performed.

Next, an example of the method of cutting the image region A(m, k) of the m-th row and k-th column from the medium M will be described. Here, a case of k=n+1 (2≦k≦N−1) will be described.

As shown in the flowchart of FIG. 11, first, a process of checking the position of the first reference point BP1(m, n) by detecting the first reference mark T1(m, n), which is formed (printed in advance) at a corner closest to the origin O of the medium M, in each image region A(m, n) of the m-th row and n-th column (1≦m≦M, 1≦n≦N) of the medium M is performed. This process is the same process as step S21 described above.

Then, a process (step S22A) of checking the position of the second reference point BP2(m, n) by detecting the second reference mark T2(m, n), which is formed at a corner aligned in the X direction with the corner where the first reference mark T1(m, n) is formed, in each image region A(m, n) of the m-th row and n-th column (1≦m≦M, 1≦n≦N) of the medium M is performed.

More specifically, in step S22A, the same process as step S2A for the image region A(1, 1) described above may be sequentially performed for each image region A(m, n). In addition, since the process for the image region A(1, 1) has already been performed in step S2A, the process for the image region A(1, 1) does not need to be repeatedly performed.

Then, at a corner in each image region A(m, k) of the m-th row and k-th column of the medium M that is adjacent to a corner where the second reference mark T2(m, k+1) is formed in the image region A(m, k+1) of the m-th row and (k+1)-th column, a process (step S23A) of predicting the position of the first prediction reference point CP1(m, k) using the second reference point BP2(m, k+1) in the image region of the m-th row and (k+1)-th column is performed. Step S23A may be performed in the same manner as step S6A described above.

Then, at a corner in each image region A(m, k) of the m-th row and k-th column of the medium M that is adjacent to a corner where the first reference mark T1(m, k+1) is formed in the image region A(m, k+1) of the m-th row and (k+1)-th column, a process of predicting the position of the second prediction reference point CP2(m, k) using the first reference point BP1(m, k+1) in the image region A(m, k+1) of the m-th row and (k+1)-th column is performed. This process is the same process as step S24 described above.

Any one of steps S23A and S24 may be performed first.

Then, the same process as step S25 described above is performed.

As described above, the boundary determination method according to the present embodiment is performed.

Then, the same process as step S26 described above is performed.

As described above, the media cutting method according to the present embodiment is performed.

### Third Embodiment

Next, a boundary determination method and a media cutting method according to a third embodiment of the present invention will be described.

The boundary determination method and the media cutting method according to the third embodiment and the cutting apparatus 1 used therein are basically the same as those in the second embodiment described above.

In addition, repeated explanation regarding the same configuration, operations and effects, and the like as in the boundary determination methods and the media cutting methods according to the above-described embodiments may be omitted.

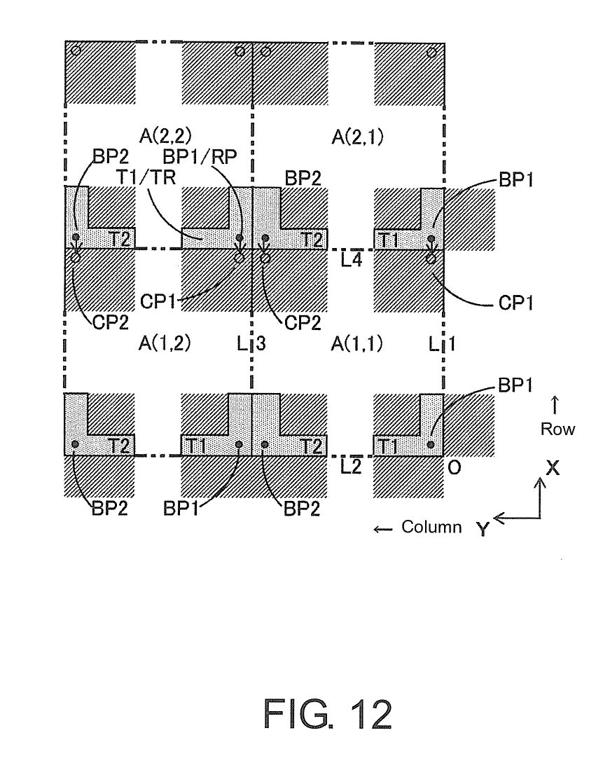

In the present embodiment, the medium M is prepared in which, in each image region A, a reference mark (first reference mark T1) is formed at a corner closest to the origin O and a reference mark (second reference mark T2) is formed at a corner aligned in the Y direction with the corner closest to the origin O (refer to FIG. 12).

Since processes according to the present embodiment may be performed by replacing the X direction in the second embodiment with the Y direction, repeated explanation thereof will be omitted herein.

### Fourth Embodiment

Next, a boundary determination method and a media cutting method according to a fourth embodiment of the present invention will be described.

The boundary determination method and the media cutting method according to the fourth embodiment are characterized in that one reference mark is formed in each image region A and media cutting is performed based on the reference mark. In addition, the configuration of the cutting apparatus 1 used in this method is the same as that in the embodiments described above.

In addition, repeated explanation regarding the same configuration, operations and effects, and the like as in the boundary determination methods and the media cutting methods according to the above-described embodiments may be omitted.

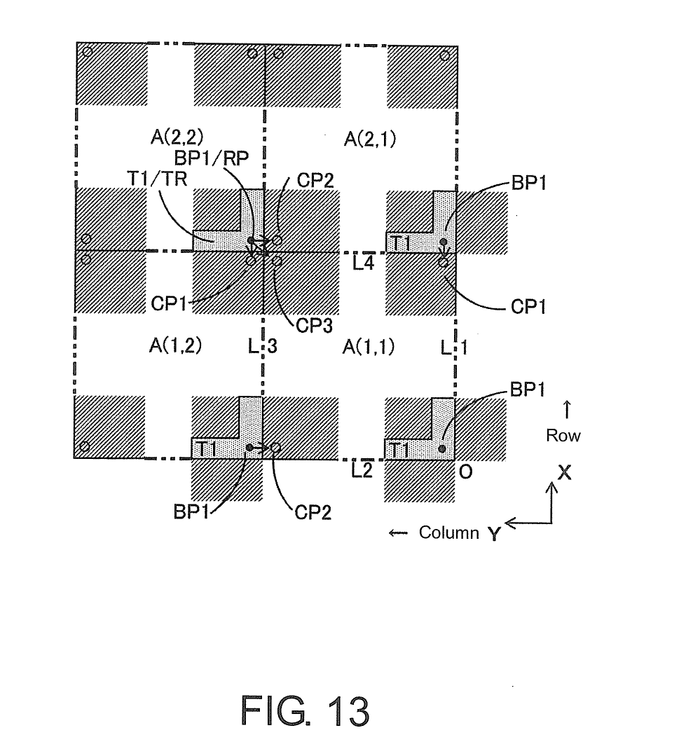

In the present embodiment, the medium M is prepared in which, in each image region A, a reference mark (first reference mark T1) is formed at a corner closest to the origin O (refer to FIG. 13).

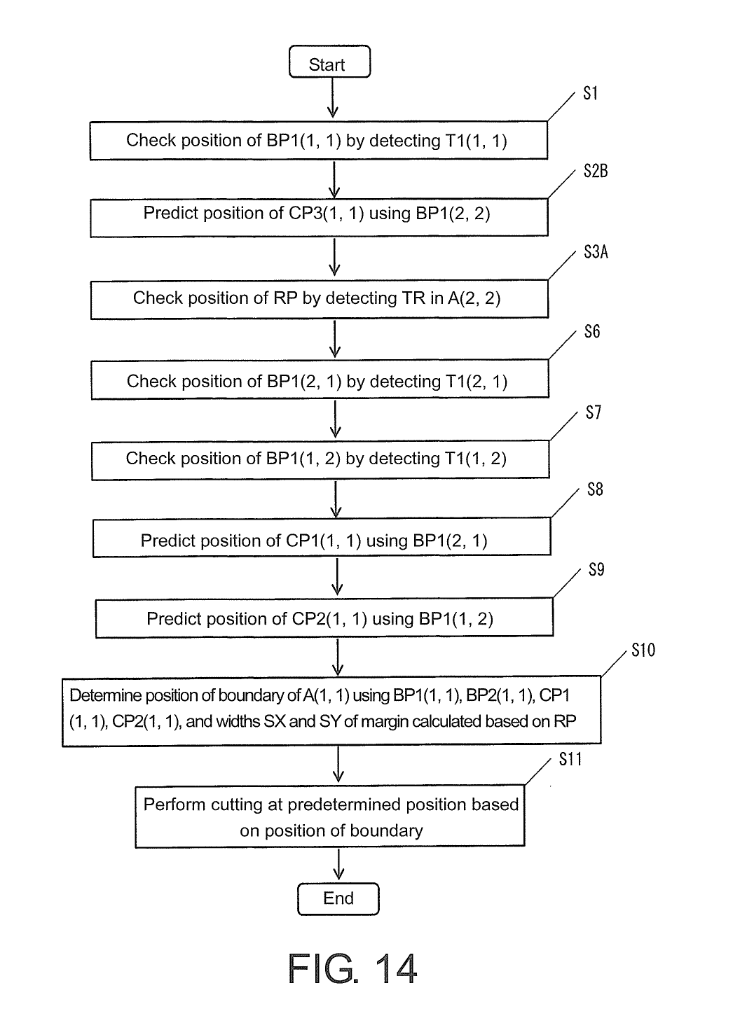

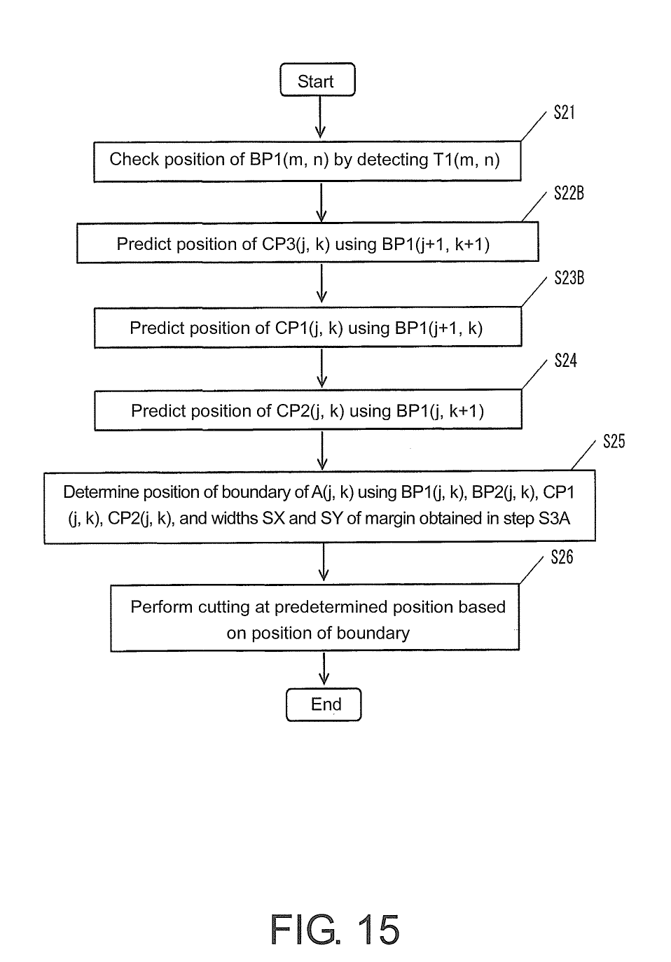

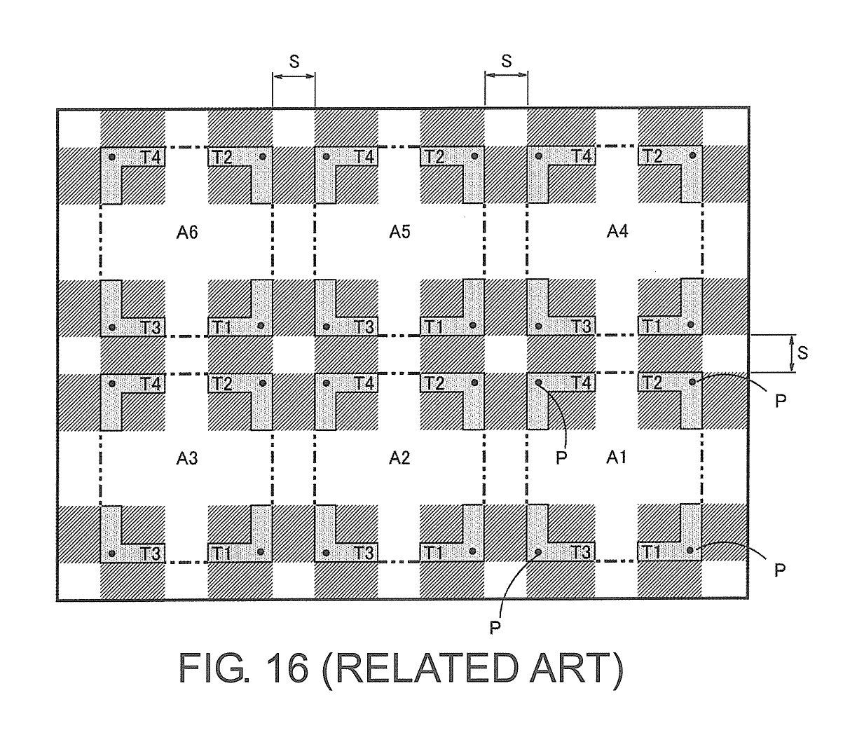

First, an example of the method of cutting the image region A(1, 1) of the first row and first column from the medium M will be described. FIGS. 14 and 15 are flowcharts showing the basic procedures of the boundary determination method and the media cutting method according to the present embodiment.

First, a process of checking the position of the first reference point BP1(1, 1) by detecting the first reference mark T1(1, 1), which is formed (printed in advance) at a corner closest to the origin O of the medium M, in the image region A(1, 1) of the first row and first column of the medium M is performed. This process is the same process as step S1 described above.

Then, at a corner in the image region A(1, 1) of the first row and first column that is adjacent to (in contact with) a corner where the first reference mark T1(2, 2) is formed in the image region A(2, 2) of the second row and second column, a process (step S2B) of predicting the position of a third prediction reference point CP3 using the first reference point BP1(2, 2) in the image region A(2, 2) of the second row and second column is performed. In addition, the third prediction reference point CP3 whose position in the image region A(1, 1) has been predicted is expressed as CP3(1, 1).

More specifically, in step S2B, the control operation section 9 calculates a predetermined position of a corner in the image region A(1, 1) adjacent to the formation position of the first reference mark T1(2, 2) in the image region A(2, 2), as the first prediction reference point CP3(1, 1) in the image region A(1, 1), using the position information of the first reference point BP1(2, 2) in the image region A(2, 2) of the second row and second column.

As a specific calculation method, a position that is separated by a predetermined distance in a predetermined direction (here, X and Y directions) from the position of the first reference point BP1(2, 2) in the image region A(2, 2) is determined by calculation, and the position is calculated as the third prediction reference point CP3(1, 1) in the image region A(1, 1).

Then, a process (step S3A) of checking the position of the reference point RP for margin detection by detecting the reference mark TR for margin detection, which is formed at a corner closest to the origin O of the medium M, in the image region A(2, 2) of the second row and second column of the medium M is performed. Step S3A can be performed in the same manner as step S3 by using the first reference point BP1(1, 1) instead of the second reference point BP2(1, 1) in step S3 of the first embodiment described above. Thus, it is possible to calculate the X-direction width SX and the Y-direction width SY of the margin between the image region A(1, 1) and the image region A(2, 2).

Then, a process of checking the position of the first reference point BP1(2, 1) (corresponding to the “third reference point” described in the appended claims) within the reference mark by detecting the first reference mark T1(2, 1) (corresponding to the “third reference mark” described in the appended claims) in the image region A(2, 1) of the second row and first column of the medium M is performed. This process is the same process as step S6 described above.

Then, a process of checking the position of the first reference point BP1(1, 2) (corresponding to the “fourth reference point” described in the appended claims) within the reference mark by detecting the first reference mark T1(1, 2) (corresponding to the “fourth reference mark” described in the appended claims), which is formed at a corner closest to the origin O of the medium M, in the image region A(1, 2) of the first row and second column of the medium M is performed. This process is the same process as step S7 described above.

Any one of steps S6 and S7 may be performed first.

Then, the same processes as steps S8 to S10 described above are performed.

As described above, the boundary determination method according to the present embodiment is performed.

Then, the same process as step S11 described above is performed.

As described above, the media cutting method according to the present embodiment is performed.

Next, an example of the method of cutting an image region A(j, k) of the j-th row and k-th column from the medium M will be described. In the present embodiment, a case of j=m+1, 2≦j≦M−1, k=n+1, and 2≦k≦N−1 will be described.

As shown in the flowchart of FIG. 15, first, a process of checking the position of the first reference point BP1(m, n) by detecting the first reference mark T1(m, n), which is formed (printed in advance) at a corner closest to the origin O of the medium M, in each image region A(m, n) of the m-th row and n-th column (1≦m≦M, 1≦n≦N) of the medium M is performed. This process is the same process as step S21 described above.

Then, at a corner in each image region A(j, k) of the j-th row and k-th column of the medium M that is adjacent to (in contact with) a corner where a first reference mark T1(j+1, k+1) is formed in an image region A(j+1, k+1) of the (j+1)-th row and (k+1)-th column, a process (step S22B) of predicting the position of a third prediction reference point CP3(j, k) using the first reference point BP1(j+1, k+1) in the image region A(j+1, k+1) is performed. Here, j=m+1, 2≦j≦M−1, k=n+1, and 2≦k≦N−1 are assumed (the same hereinbelow).

More specifically, in step S22B, the control operation section 9 calculates a predetermined position of a corner in the image region A(j, k) of the j-th row and k-th column adjacent to (in contact with) the formation position of the first reference mark T1(j+1, k+1) in the image region A(j+1, k+1), as the third prediction reference point CP3(j, k) in the image region A(j, k), using the position information of the first reference point BP1(j+1, k+1) in the image region A(j+1, k+1) of the (j+1)-th row and (k+1)-th column obtained in step S21.

As a specific calculation method, a position that is separated by a predetermined distance in a predetermined direction (here, X and Y directions) from the position of the first reference point BP1(j+1, k+1) in the image region A(j+1, k+1) is determined by calculation, and the position is calculated as the third prediction reference point CP3(j, k) in the image region A(j, k).

Then, at a corner in each image region A(j, k) of the j-th row and k-th column of the medium M that is adjacent to a corner where a first reference mark T1(j+1, k) is formed in an image region A(j+1, k) of the (j+1)-th row and k-th column, a process (step S23B) of predicting the position of a first prediction reference point CP1(j, k) using the first reference point BP1(j+1, k) in the image region A(j+1, k) of the (j+1)-th row and k-th column is performed. Step S23B is the same process as step S6 described above.

Then, at a corner in each image region A(j, k) of the j-th row and k-th column of the medium M that is adjacent to a corner where the first reference mark T1(j, k+1) is formed in the image region A(j, k+1) of the j-th row and (k+1)-th column, a process of predicting the position of the second prediction reference point CP2(j, k) using the first reference point BP1(j, k+1) in the image region A(j, k+1) of the j-th row and (k+1)-th column is performed. This process is the same process as step S24 described above.

Any one of steps S23B and S24 may be performed first.

Then, the same process as step S25 described above is performed.

As described above, the boundary determination method according to the present embodiment is performed.

Then, the same process as step S26 described above is performed.

As described above, the media cutting method according to the present embodiment is performed.

According to the media cutting method of the present embodiment, the same operations and effects as in the embodiments described above can be achieved. In particular, it is possible to perform boundary determination and cutting by forming only one reference mark in each image region on the medium M that is a target to be cut. Therefore, since it is possible to reduce the time required until the cutting of each image region from the formation of the reference mark more than in the embodiments described above, it is possible to greatly reduce the tact time of processing.

As described above, according to the boundary determination method disclosed, when determining the position of the boundary of each image region on the medium, it is possible to reduce both the time taken to form a reference mark on the medium and the time taken to detect the reference mark. Therefore, it is possible to greatly reduce the time required for the determination of the boundary position and the time required for the media cutting process based on the boundary position. In addition, since a margin portion of a medium to be processed can be eliminated when performing the media cutting process, the waste of the medium can be prevented. As a result, it is possible to reduce the cost.

In particular, the following characteristic operations and effects are achieved by the present embodiment.

The boundary determination method disclosed is a method of determining a position of a boundary between first and second image regions arranged on the medium M. The boundary determination method includes: a detection step of checking position information of the first image region by detecting a reference mark that is formed in the first image region in order to indicate a position of the first image region; a prediction step of predicting position information of the second image region based on the position information of the first image region; and a determination step of determining the position of the boundary based on positional relationship between the first and second image regions calculated using the position information of the first and second image regions. In this case, since the prediction step is included, a larger amount of position information than the amount of information of positions actually formed can be used when performing the determination step. Therefore, it is possible to increase the accuracy of boundary determination (calculation).

In addition, in the present invention, preferably, the first and second image regions are image regions having the same shape and size arranged adjacent to each other on the medium M, and the prediction step is a step of predicting the position information of the second image region using the position information and shape information of the first image region and shape information of the second image region. In this case, since the position information of the second image region is predicted using not only the position information of the first and second image regions but also the shape information of the first and second image regions, it is possible to further increase the accuracy of the position information of the second image region. Therefore, an effect that the accuracy of boundary determination (calculation) is further improved is obtained.

In addition, in the present invention, preferably, the first and second image regions are two adjacent image regions of a plurality of rectangular image regions arranged in a matrix on the medium M, and the prediction step is a step of predicting the position information of the second image region by calculation to translate the position information of the first image region. In this case, it is possible to predict (calculate) the position information of the second image region using a simple calculation method.

In addition, the boundary determination method disclosed is a method of determining a position (for example, L1 to L4) of a boundary of each image region A on the sheet-like medium M on which rectangular image regions having the same shape and size are arranged in a matrix in X and Y directions. The boundary determination method includes: a step (S1) of checking a position of a first reference point BP1(1, 1) by detecting a first reference mark T1(1, 1), which is formed at a corner closest to the origin O of the medium M, in an image region A(1, 1) of first row and first column of the medium M; a step (S2) of checking a position of a second reference point BP2(1, 1) by detecting a second reference mark T2(1, 1), which is formed at a corner different from the corner where the first reference mark is formed, in the image region A(1, 1) of first row and first column; a step (S3) of checking a position of a reference point RP for margin detection by detecting a reference mark TR for margin detection, which is formed at a corner closest to the origin O of the medium M, in an image region A(2, 2) of second row and second column of the medium M; and a step (S4) of determining a position (for example, L1 to L4) of a boundary in the image region A(1, 1) of first row and first column using the first reference point BP1(1, 1), the second reference point BP2(1, 1), and an X-direction width SX and a Y-direction width SY of a margin adjacent to the image region A(1, 1) of first row and first column calculated using the reference point RP for margin detection.

In this case, by forming only two reference marks (here, T1 and T2) in each image region A on the sheet-like medium M on which rectangular image regions having the same shape and size are arranged in a matrix in X and Y directions, it is possible to determine the position (for example, L1 to L4) of the boundary of the image region A(1, 1) of first row and first column on the medium M. Therefore, it is possible to cut the image region A(1, 1) at a predetermined cutting position set based on the position of the boundary (for example, L1 to L4). As a result, it is possible to reduce both the time required to form (print) the reference marks T1 and T2 and the time required to detect the reference marks T1 and T2. Thus, since it is possible to significantly reduce the time required until the cutting of each image region A from the formation of the reference marks T1 and T2, the tact time of processing can be greatly reduced. As a result, it is possible to improve the processing efficiency.

In addition, it is possible to realize a configuration in which reference marks T1 and T2 in the adjacent image regions A are not arranged adjacent to each other. Therefore, since it is possible to detect the reference marks T1 and T2 even if there is no margin between adjacent image regions, it is possible to eliminate the margin. In this manner, the problem that the margin portion is wasted can be solved. In addition, since the medium itself can be reduced in size, it is possible to reduce the cost.

In addition, in the present invention, preferably, the steps (S1) to (S3) are included, and following steps are included instead of the step (S4). The following steps are: a step (S6) of checking a position of a third reference point (here, BP1(2, 1)) by detecting a third reference mark (here, T1(2, 1)), which is formed at a corner closest to the origin O of the medium M, in an image region A(2, 1) of second row and first column of the medium; a step (S7) of checking a position of a fourth reference point (here, BP1(1, 2)) by detecting a fourth reference mark (here, T1(1, 2)), which is formed at a corner closest to the origin O of the medium M, in an image region A(1, 2) of first row and second column of the medium; a step (S8) of predicting a position of a first prediction reference point CP1(1, 1) at a corner in the image region A(1, 1) of first row and first column, which is adjacent to the corner in the image region A(2, 1) of second row and first column where the third reference mark (here, T1(2, 1)) is formed, using the third reference point (here, BP1(2, 1)) in the image region A(2, 1) of second row and first column; a step (S9) of predicting a position of a second prediction reference point CP2(1, 1) at a corner in the image region A(1, 1) of first row and first column, which is adjacent to the corner in the image region A(1, 2) of first row and second column where the fourth reference mark (here, T1(1, 2)) is formed, using the fourth reference point (here, BP1(1, 2)) in the image region A(1, 2) of first row and second column; and a step (S 10) of determining a position (for example, L1 to L4) of a boundary in the image region A(1, 1) of first row and first column using the first reference point BP1(1, 1), the second reference point BP2(1, 1), the first prediction reference point CP1(1, 1), the second prediction reference point CP2(1, 1), and an X-direction width SX and a Y-direction width SY of a margin adjacent to the image region A(1, 1) of first row and first column calculated using the reference point RP for margin detection. In this case, it is possible to obtain the position information of four points (first reference point BP1(1, 1), second reference point BP2(1, 1), first prediction reference point CP1(1, 1), and second prediction reference point CP2(1, 1)) and the information SX and SY of a margin by forming only two reference marks (here, T1 and T2) in each image region A on the medium M. Therefore, it is possible to further increase the calculation accuracy by calculating the boundary position (for example, L1 to L4) using the information. In particular, even when not only a margin but also skew is present, it is possible to calculate the boundary position with high accuracy.

In addition, the boundary determination method disclosed is a method of determining a position of a boundary of each image region on a sheet-like medium on which rectangular image regions A having the same shape and size are arranged in a matrix of M rows and N columns (M and N are natural numbers) in X and Y directions. The boundary determination method includes: the steps (S1) to (S4) or the steps (S1) to (S3) and (S6) to (S10) in the boundary determination method described above; a step (S21) of checking a position of a first reference point BP1(m, n) by detecting a first reference mark T1(m, n), which is formed at a corner closest to the origin O of the medium M, in each image region A(m, n) of m-th row and n-th column (1≦m≦M, 1≦n≦N) of the medium M, the step (S21) overlapping the step (S1) or not overlapping the step (S1); a step (S22) of checking a position of a second reference point BP2(m, n) by detecting a second reference mark T2(m, n), which is formed at a corner different from the corner where the first reference mark T1(m, n) is formed, in each image region A(m, n) of m-th row and n-th column, the step (S22) overlapping the step (S2) or not overlapping the step (S2); a step (S23) of predicting a position of a first prediction reference point CP1(m, k) at a corner in each image region A(m, k) of m-th row and k-th column (k=n+1, where 2≦k≦N−1) of the medium, which is adjacent to a corner in an image region A(m, k−1) of m-th row and (k−1)-th column where the second reference mark T2(m, k−1) is formed, using the second reference point BP2(m, k−1) in the image region A(m, k−1) of m-th row and (k−1)-th column; a step (S24) of predicting a position of a second prediction reference point CP2(m, k) at a corner in each image region A(m, k) of m-th row and k-th column of the medium, which is adjacent to a corner in an image region A(m, k+1) of m-th row and (k+1)-th column where the first reference mark BP1(m, k+1) is formed, using the first reference point BP1(m, k+1) in the image region A(m, k+1) of m-th row and (k+1)-th column; and a step (S25) of determining a position (for example, L1 to L4) of a boundary in each image region A(m, k) of m-th row and k-th column using the first reference point BP1(m, k), the second reference point BP2(m, k), the first prediction reference point CP1(m, k), the second prediction reference point CP2(m, k), and the widths SX and XY of the margin in each image region A(m, k) of m-th row and k-th column.

In this case, by forming only two reference marks (here, T1 and T2) in each image region A(m, k) on the sheet-like medium M on which rectangular image regions A(m, k) the same shape and size are arranged in a matrix in X and Y directions, it is possible to determine the position (for example, L1 to L4) of the boundary of the image region A(m, k) of m-th row and k-th column on the medium M. Therefore, it is possible to cut the image region A(m, k) at a predetermined cutting position set based on the position (for example, L1 to L4) of the boundary. As a result, in the same manner as described above, it is possible to reduce both the time required to form (print) the reference marks T1 and T2 and the time required to detect the reference marks T1 and T2. Thus, since it is possible to significantly reduce the time required until the cutting of each image region A(k) from the formation of the reference marks T1 and T2, the tact time of processing can be greatly reduced. As a result, it is possible to improve the processing efficiency. In addition, it is possible to realize a configuration in which reference marks T1 and T2 in the adjacent image regions A are not arranged adjacent to each other. Therefore, since it is possible to detect the reference marks T1 and T2 even if there is no margin between adjacent image regions, it is possible to eliminate the margin. In this manner, the problem that the margin portion is wasted can be solved. In addition, since the medium itself can be reduced in size, it is possible to reduce the cost.

In addition, the media cutting method disclosed includes: determining a position (for example, L1 to L4) of a boundary by performing the steps in the boundary determination method described above; and cutting the medium M at a predetermined position calculated based on the position (for example, L1 to L4) of the boundary. In this case, since it is possible to significantly reduce the time required until the cutting of each image region A from the formation of the reference marks T1 and T2, the tact time of processing can be greatly reduced. In addition, since the waste of the medium can be prevented, it is possible to reduce the cost.

In addition, it is needless to say that the present invention is not limited to the embodiments described above and various changes can be made without departing from the spirit and scope of the present invention.

In particular, although the configuration of the medium M on which the reference marks T1 and T2 are formed at corners in each image region A has been described as an example, the reference mark may also be formed at the outer edge other than the corner without being limited to the above example. In addition, providing the reference mark near the center without being limited to the outer edge may also be considered. However, it is preferable to form the reference mark at the outer edge in terms of securing a wider image forming region.

In addition, although the configuration in which two reference marks (or one reference mark) are formed in one image region has been described as an example in the above embodiments, three reference marks may be formed in one image region, for example.

What is claimed is:

1. A boundary determination method for determining a position of a boundary between a first image region and a second image region arranged on a medium, and the boundary determination method comprising:
a detection step of checking a position information of the first image region by detecting a reference mark that is formed in the first image region in order to indicate a position of the first image region;
a prediction step of predicting a position information of the second image region based on the position information of the first image region; and
a determination step of determining the position of the boundary based on a positional relationship between the first image region and the second image region calculated by using the position information of the first image region and the second image region.

2. The boundary determination method according to claim 1, wherein
the first image region and the second image region are image regions having the same shape and size arranged adjacent to each other on the medium, and
the prediction step is a step of predicting the position information of the second image region by using the position information and shape information of the first image region and shape information of the second image region.

3. The boundary determination method according to claim 1, wherein
the first image region and second image region are two adjacent image regions of a plurality of rectangular image regions arranged in a matrix on the medium, and
the prediction step is a step of predicting the position information of the second image region by calculation to translate the position information of the first image region.

4. A boundary determination method for determining a position of a boundary of each image region on a sheet-like medium on which rectangular image regions having the same shape and size are arranged in a matrix in X and Y directions, and the boundary determination method comprising:
a step S1 of checking a position of a first reference point by detecting a first reference mark, which is formed at a corner closest to an origin set as a reference position of the medium, in an image region of first row and first column of the medium;
a step S2 of checking a position of a second reference point by detecting a second reference mark, which is formed at a corner different from the corner where the first reference mark is formed, in the image region of first row and first column;
a step S3 of checking a position of a reference point for margin detection by detecting a reference mark for margin detection, which is formed at a corner closest to the origin, in an image region of second row and second column of the medium; and
a step S4 of determining a position of a boundary in the image region of first row and first column by using the first reference point, the second reference point, and an X-direction width and a Y-direction width of a margin adjacent to the image region of first row and first column calculated by using the reference point for margin detection.

5. The boundary determination method according to claim 4, wherein
the steps S1 to S3 are included, and following steps are included instead of the step S4, and
the following steps are:
a step S6 of checking a position of a third reference point by detecting a third reference mark, which is formed at a corner closest to the origin, in an image region of second row and first column of the medium;
a step S7 of checking a position of a fourth reference point by detecting a fourth reference mark, which is formed at a corner closest to the origin, in an image region of first row and second column of the medium;
a step S8 of predicting a position of a first prediction reference point at a corner in the image region of first row and first column, which is adjacent to the corner in the image region of second row and first column where the third reference mark is formed, by using the third reference point in the image region of second row and first column;
a step S9 of predicting a position of a second prediction reference point at a corner in the image region of first row and first column, which is adjacent to the corner in the image region of first row and second column where the fourth reference mark is formed, by using the fourth reference point in the image region of first row and second column; and
a step S10 of determining a position of a boundary in the image region of first row and first column by using the first reference point, the second reference point, the first prediction reference point, the second prediction reference point, and an X-direction width and a Y-direction width of a margin adjacent to the image region of first row and first column calculated by using the reference point for margin detection.

6. A boundary determination method for determining a position of a boundary of each image region on a sheet-like medium on which rectangular image regions having the same shape and size are arranged in a matrix of M rows and N columns in X and Y directions, where M and N are natural numbers, and the boundary determination method comprising:
the steps in the boundary determination method according to claim 4;
a step S21 of checking a position of a first reference point by detecting a first reference mark, which is formed at a corner closest to the origin of the medium, in each image region of m-th row and n-th column of the medium, where 1≦m≦M, 1≦n≦N, and M and N are natural numbers, and the step S21 is overlapping the step S1 or not overlapping the step S1;
a step S22 of checking a position of a second reference point by detecting a second reference mark, which is formed at a corner different from the corner where the first reference mark is formed, in each image region of m-th row and n-th column, and the step S22 is overlapping the step S2 or not overlapping the step S2;
a step S23 of predicting a position of a first prediction reference point at a corner in each image region of m-th row and k-th column of the medium, which is adjacent to a corner in an image region of m-th row and (k−1)-th column where the second reference mark is formed, by using the second reference point in the image region of m-th row and (k−1)-th column, where k=n+1, and 2≦k≦N−1;
a step S24 of predicting a position of a second prediction reference point at a corner in each image region of m-th row and k-th column of the medium, which is adjacent to a corner in an image region of m-th row and (k+1)-th column where the first reference mark is formed, by using the first reference point in the image region of m-th row and (k+1)-th column; and
a step S25 of determining a position of a boundary in each image region of m-th row and k-th column by using the first reference point, the second reference point, the first prediction reference point, the second prediction reference point, and the widths of the margin in each image region of m-th row and k-th column.

7. A media cutting method, comprising:
determining a position of the boundary by performing the steps in the boundary determination method according to claim 1; and
cutting the medium at a predetermined position calculated based on the position of the boundary.

8. A media cutting method, comprising:
determining a position of the boundary by performing the steps in the boundary determination method according to claim 4; and
cutting the medium at a predetermined position calculated based on the position of the boundary.
